(19) United States
(12) Patent Application Publication
(10) Pub. No.: US 2018/0254808 A1
(43) Pub. Date: Sep. 6, 2018

(54) TERMINAL DEVICE, BASE STATION DEVICE, AND WIRELESS COMMUNICATION SYSTEM

(71) Applicant: Panasonic Corporation, Osaka (JP)

(72) Inventors: MASASHI KOBAYASHI, Tokyo (JP); KOJI TAKINAMI, Kanagawa (JP); SHOZO OKASAKA, Kanagawa (JP)

(21) Appl. No.: 15/908,536

(22) Filed: Feb. 28, 2018

(30) Foreign Application Priority Data
Mar. 3, 2017 (JP) 2017-040848

(51) Int. Cl. H04B 7/06

(52) U.S. Cl. CPC H04B 7/061; H04B 7/0617; H04B 7/0639

(57) ABSTRACT

A terminal device includes a communicator that, after first data communication carried out with the use of a narrowly directional first beam, receives, by using a widely directional beam, a plurality of first signals that a base station device has transmitted by using respective narrowly directional beams, and a determination circuitry that calculates the reception quality of the plurality of first signals and determines a narrowly directional second beam that the base station device uses for communication. The communicator transmits a feedback signal including information indicating the second beam to the base station device by using the first beam and starts second data communication by using the first beam in a case in which the communicator has received, by using the first beam, a response indicating that the base station device has received the feedback signal.

### BACKGROUND

### 1. Technical Field

The present disclosure relates to terminal devices, base station devices, and wireless communication systems.

### 2. Description of the Related Art

With increased levels of functionality of digital devices, access points and terminal devices provided with wireless local area networks (LANs) are widespread. In recent years, increased needs for high-capacity, high-speed wireless communication have led to the spread of high-speed wireless LANs that go beyond gigabit speed.

To implement high-capacity, high-speed wireless communication, high-speed wireless communication in millimeter-wave bands (e.g., 60-GHz band) in which directional communication is carried out with the use of a plurality of antenna elements is attracting attention (e.g., IEEE 802.11ad-2012 standard, Dec. 28, 2012).

Some of the characteristics of wireless signals in millimeter-wave bands are their strong straightness and high spatial propagation losses. As such, according to IEEE 802.11ad-2012 standard, Dec. 28, 2012, a wireless communication device (e.g., access point, base station device, terminal device) executes procedures called beamforming training (BFT) in which the wireless communication device transmits and receives training signals to and from each communicating party and determines the direction with high communication quality, and carries out wireless communication by forming an antenna pattern (hereinafter, referred to as a “beam”) that is highly directional in the determined direction.

### SUMMARY

However, wireless communication devices of existing techniques carry out the BFT periodically and change the beams, which thus leads to an increase in the frequency of transmitting and receiving training signals and to a decrease in the communication throughput.

One non-limiting and exemplary embodiment provides a terminal device, a base station device, and a wireless communication system that suppress a decrease in the communication throughput.

In one general aspect, the techniques disclosed here feature a terminal device that includes a communicator that carries out first data communication with a base station device by using a first beam and then receives, by using a reception beam, a plurality of first signals transmitted by the base station device by using respective transmission beams; and a determiner that calculates a reception quality of the plurality of first signals and determines a second beam of which the reception quality is the highest among the plurality of transmission beams. The communicator transmits a feedback signal including information indicating the second beam to the base station device by using the first beam and starts second data communication with the base station device by using the first beam in a case in which the communicator has received, from the base station device, a response signal indicating that the base station device has received the feedback signal.

According to an aspect of the present disclosure, a decrease in the communication throughput can be suppressed.

It is to be noted that general or specific embodiments of the above may be implemented in the form of a system, an integrated circuit, a computer program, or a recording medium, or through any desired combination of a system, an apparatus, a method, an integrated circuit, a computer program, and a recording medium.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A illustrates an example of an operation A in BFT;

FIG. 1B illustrates an example of an operation B in BFT;

FIG. 1C illustrates an example of an operation C in BFT;

FIG. 1D illustrates an example of an operation D in BFT;

FIG. 2 is a sequence diagram illustrating an example of the flow of the operation A to the operation D illustrated in FIG. 1A to FIG. 1D;

FIG. 3 illustrates an example of a configuration of a wireless communication device according to a first embodiment of the present disclosure;

FIG. 4 is a sequence diagram illustrating an example of a series of operations according to the first embodiment of the present disclosure;

FIG. 5A illustrates examples of operation patterns according to the first embodiment of the present disclosure;

FIG. 5B illustrates a correspondence of the operation patterns illustrated in FIG. 5A with a base station device and a terminal device;

FIG. 6 is a flowchart illustrating processing of a base station device according to the first embodiment of the present disclosure;

FIG. 7 is a flowchart illustrating processing of a terminal device according to the first embodiment of the present disclosure;

FIG. 8A is a sequence diagram illustrating an example of a series of operations according to a second embodiment of the present disclosure;

FIG. 8B is a sequence diagram illustrating an example of a series of operations according to the second embodiment of the present disclosure;

FIG. 9A illustrates examples of operation patterns according to the second embodiment of the present disclosure;

FIG. 9B illustrates a correspondence of the operation patterns illustrated in FIG. 9A with a base station device, a terminal device, and a link disconnecting timing;

FIGS. 10A and 10B are a flowchart illustrating processing of a base station device according to the second embodiment of the present disclosure; and

FIGS. 11A and 11B are a flowchart illustrating processing of a terminal device according to the second embodiment of the present disclosure.

### DETAILED DESCRIPTION

First, beamforming training (BFT) of existing techniques will be described. In the BFT of the existing techniques, primarily four operations are carried out. Hereinafter, these four operations will be referred to sequentially as an operation A, an operation B, an operation C, and an operation D.

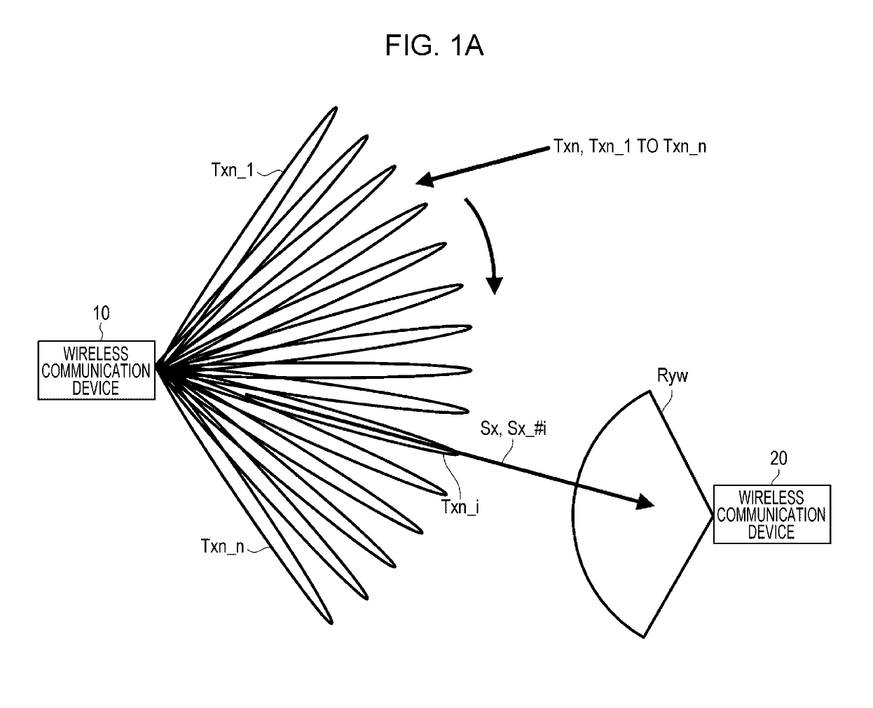

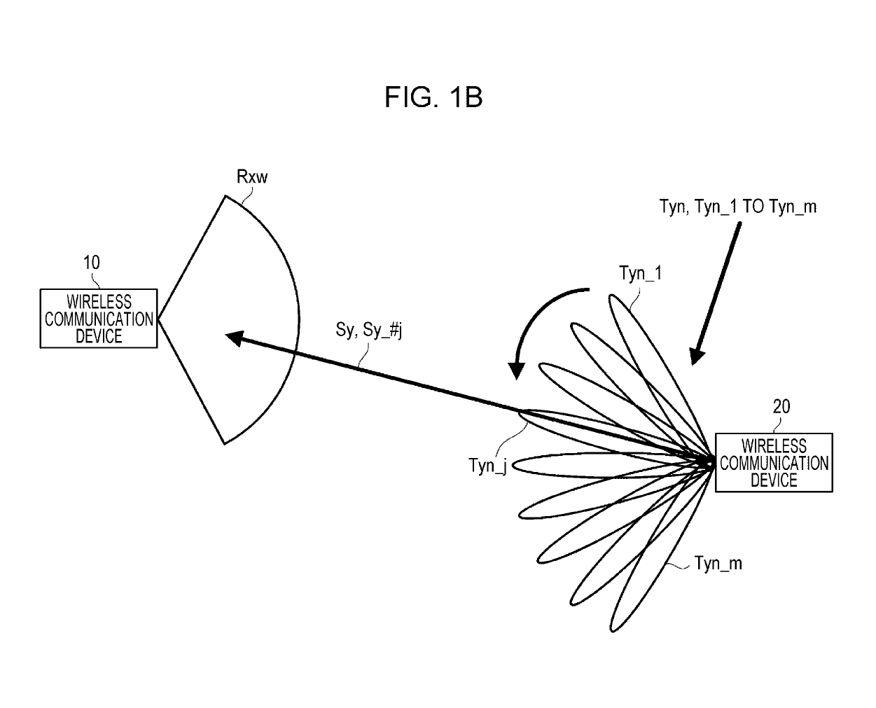

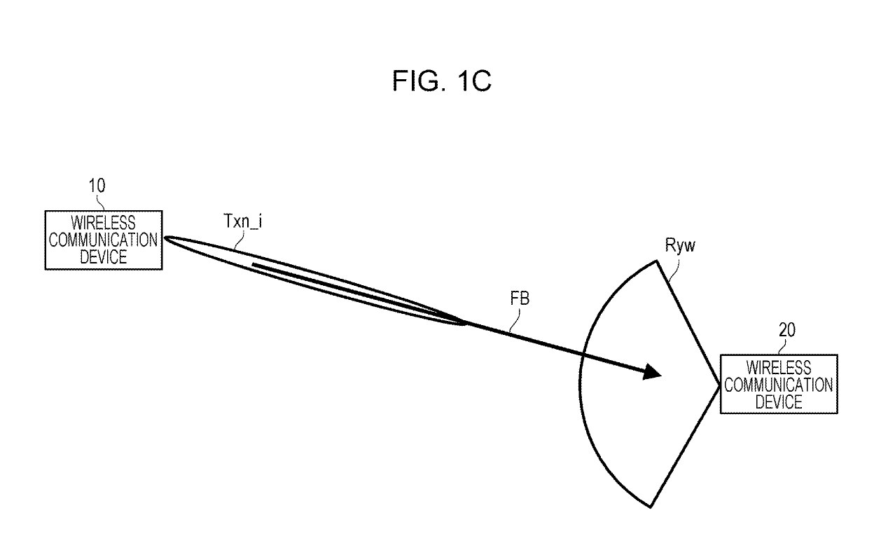

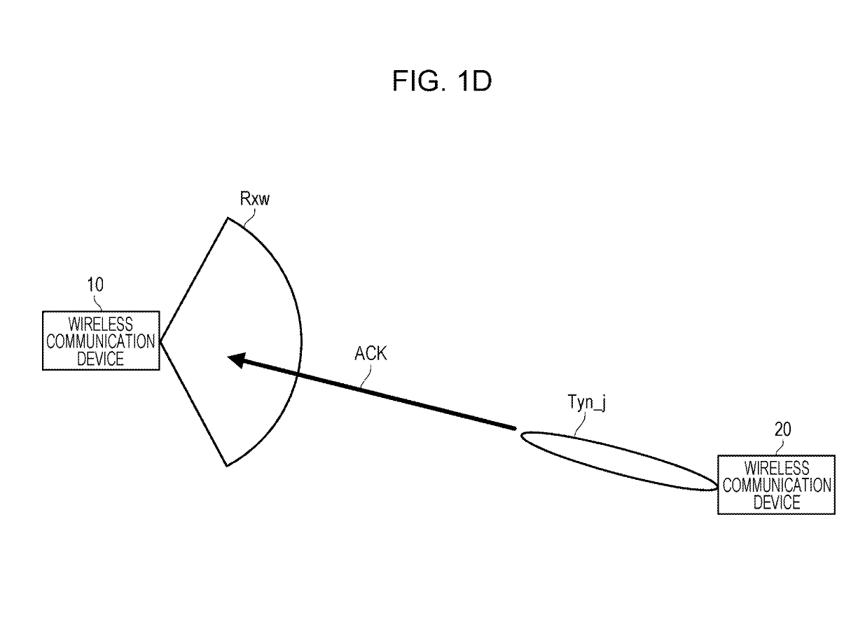

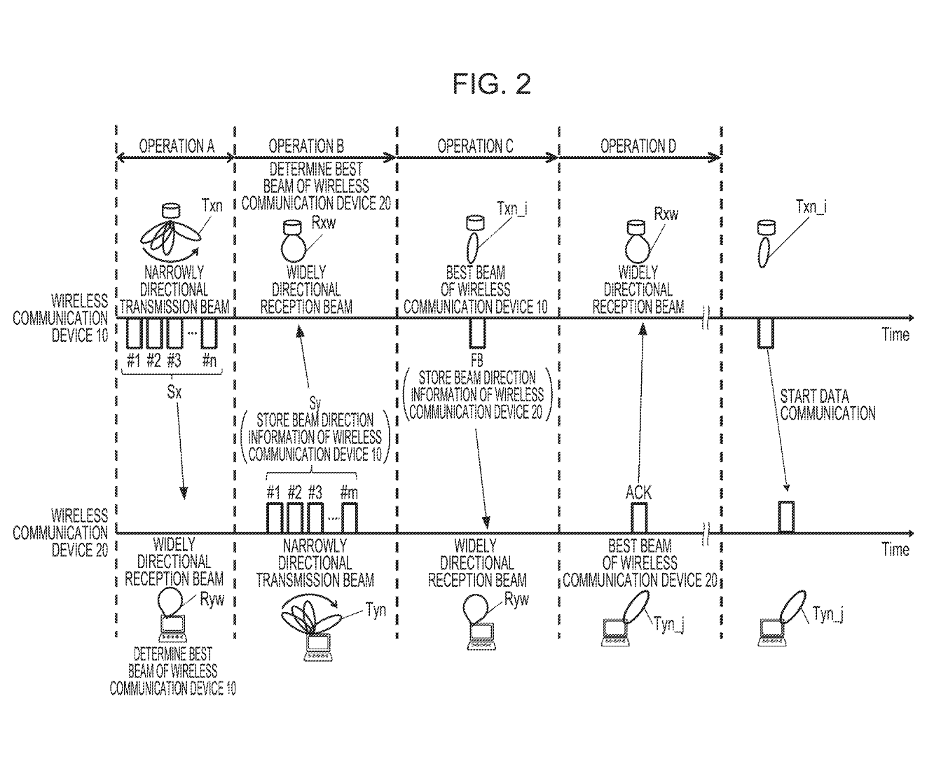

FIG. 1A illustrates an example of the operation A in the BFT. FIG. 1B illustrates an example of the operation B in the BFT. FIG. 1C illustrates an example of the operation C in the BFT. FIG. 1D illustrates an example of the operation D in the BFT. FIG. 2 is a sequence diagram illustrating an example of the flow of the operation A to the operation D illustrated in FIG. 1A to FIG. 1D. The operation A to the operation D illustrated in FIG. 2 correspond to FIG. 1A to FIG. 1D, respectively.

FIG. 1A to FIG. 1D illustrate the respective operations in the BFT implemented between a wireless communication device 10 and another wireless communication device 20. In the following description, the characteristics of transmitting antenna patterns and the characteristics of receiving antenna patterns are substantially equal between the wireless communication device 10 and the wireless communication device 20.

The wireless communication device 10 and the wireless communication device 20 each include a plurality of antenna elements and each carry out beamforming of electronically switching the beam direction by selecting an antenna element and by controlling the phase of the reception and transmission radio waves of the selected antenna element. The BFT is an operation of determining the beamform suitable for communication (e.g., the beam direction suitable for communication) in response to a change in the communication environment between the wireless communication device 10 and the wireless communication device 20.

In FIG. 1A, first, the wireless communication device 10 transmits training signals Sx in respective beam directions by using (narrowly directional) transmission beams Txn (Txn_1 to Txn_n) with a narrow directionality while switching the beam direction of the transmission beam Txn among a plurality of beam directions. The training signals Sx transmitted with the use of the transmission beams Txn in the respective beam directions include the identification information of the corresponding beam directions. The (narrowly directional) beam with a narrow directionality is a beam having a small beam-half-value angle. It is to be noted that each beam indicates the transmitting direction or the receiving direction, and although the transmission beams Txn and a reception beam Ryw do not overlap in FIG. 1A, the communication is possible.

The wireless communication device 20 forms a (widely directional) reception beam Ryw with a wide directionality and stands by until the wireless communication device 20 receives the training signals Sx transmitted from the wireless communication device 10. Then, the wireless communication device 20 calculates the reception quality of the received training signals Sx and determines the training signal Sx with the highest reception quality (Sx_#i in FIG. 1A). The beam direction indicated by the identification information included in the training signal Sx with the highest reception quality is the beam direction of the wireless communication device 10 that is optimal in the communication with the wireless communication device 20 (the best beam of the wireless communication device 10). The (widely directional) beam with a wide directionality is a beam having a large beam-half-value angle.

Upon having finished receiving the training signals Sx in FIG. 1A, the wireless communication device 20 transmits training signals Sy by using (narrowly directional) transmission beams Tyn (Tyn_1 to Tyn_m) with a narrow directionality in respective beam directions while switching the beam direction of the transmission beam Tyn among a plurality of beam directions in FIG. 1B. The wireless communication device 20 incorporates, into the training signals Sy, the identification information of the beam direction included in the training signal Sx with the highest reception quality (in FIG. 1A, the identification information of the beam direction included in the training signal Sx_#i) among the training signals Sx received by using the reception beam Ryw. The identification information of the beam direction included in the training signal Sx with the highest reception quality indicates the beam direction information of the wireless communication device 10 that is optimal in the communication with the wireless communication device 20.

Upon having finished transmitting the training signals Sx in FIG. 1A, the wireless communication device 10 forms a widely directional reception beam Rxw and stands by until the wireless communication device 10 receives the training signals Sy transmitted from the wireless communication device 20 in FIG. 1B. Then, the wireless communication device 10 calculates the reception quality of the received training signals Sy and determines the training signal Sy with the highest reception quality (Sy_#j in FIG. 1B). The beam direction indicated by the identification information included in the training signal Sy with the highest reception quality is the beam direction of the wireless communication device 20 that is optimal in the communication with the wireless communication device 10 (the best beam of the wireless communication device 20).

Upon having finished receiving the training signals Sy in FIG. 1B, the wireless communication device 10 sets the transmission beam optimal in the communication with the wireless communication device 20 (the narrowly directional transmission beam Txn_i in FIG. 1C) on the basis of the identification information of the beam direction included in the training signal Sy in FIG. 1C. Then, the wireless communication device 10 transmits a feedback (hereinafter, abbreviated to FB) by using the transmission beam Txn_i. The FB includes the identification information of the beam direction included in the training signal Sy with the highest reception quality (the identification information of the beam direction included in the training signal Sy_#j in FIG. 1B) among the training signals Sy received by using the reception beam Rxw. The identification information of the beam direction included in the training signal Sy with the highest reception quality indicates the beam direction information of the wireless communication device 20 that is optimal in the communication with the wireless communication device 10.

Upon having finished transmitting the training signals Sy in FIG. 1B, the wireless communication device 20 forms the widely directional reception beam Ryw and receives the FB transmitted from the wireless communication device 10 in FIG. 1C.

Upon having finished receiving the FB in FIG. 1C, the wireless communication device 20 sets the transmission beam optimal in the communication with the wireless communication device 10 (the narrowly directional transmission beam Tyn_j in the example illustrated in FIG. 1D) on the basis of the identification information of the beam direction included in the FB in FIG. 1D. Then, the wireless communication device 20 transmits an acknowledgement (ACK) to the wireless communication device 10.

Upon having finished transmitting the FB in FIG. 1C, the wireless communication device 10 forms the widely directional reception beam Rxw and stands by until the wireless communication device 10 receives the ACK transmitted from the wireless communication device 20 in FIG. 1D.

The wireless communication device 10 completes the BFT operation upon having received the ACK and starts data communication with the wireless communication device 20. The wireless communication device 10 transmits and receives data signals by using the narrowly directional beam Txn_i, and the wireless communication device 20 transmits and receives data signals by using the narrowly directional beam Tyn_j.

Through the BFT operation illustrated in FIG. 1A to FIG. 1D and FIG. 2, the wireless communication device 10 and the wireless communication device 20 determine their respective best beams. It is to be noted that the wireless communication device 20 may start the BFT described above.

For example, in a case in which at least one of the wireless communication device 10 and the wireless communication device 20 is a portable information terminal device (mobile terminal device) and the other one of the two is a base station device, an area with a high density of mobile terminal devices is likely to appear, and the relative position of the base station device and the mobile terminal device is likely to change. Therefore, in the existing techniques, the BFT is carried out periodically to retain the communication. The base station device extends the communication distance by reducing the half-value angle of the beam, and thus the number of beams to scan increases as compared to that of the mobile terminal device. Consequently, the increase in the number of beams and the increase in the frequency of the BFT lead to an increase in the frequency of transmitting training signals, which thus leads to a decrease in the throughput in data communication.

In the meantime, for example, in an environment in which the density of the mobile terminal devices and/or the relative position of the base station device and the mobile terminal device do/does not change, the best beam determined in the BFT may be identical to the best beam used in the data communication prior to the BFT. In such a case, the base station device and the mobile terminal device can refrain from changing their beam directions.

Accordingly, by checking, in the second and subsequent instances of BFT, whether the best beam used by a wireless communication device in the first instance of data communication carried out prior to carrying out the second and subsequent instances of BFT can continue to be used in the second and subsequent instances of data communication, the second and subsequent instances of BFT may possibly be abbreviated. This observation has lead to the present disclosure.

Hereinafter, embodiments of the present disclosure will be described in detail with reference to the drawings. It is to be noted that the embodiments described hereinafter are merely examples, and the present disclosure is not limited by the following embodiments.

### First Embodiment

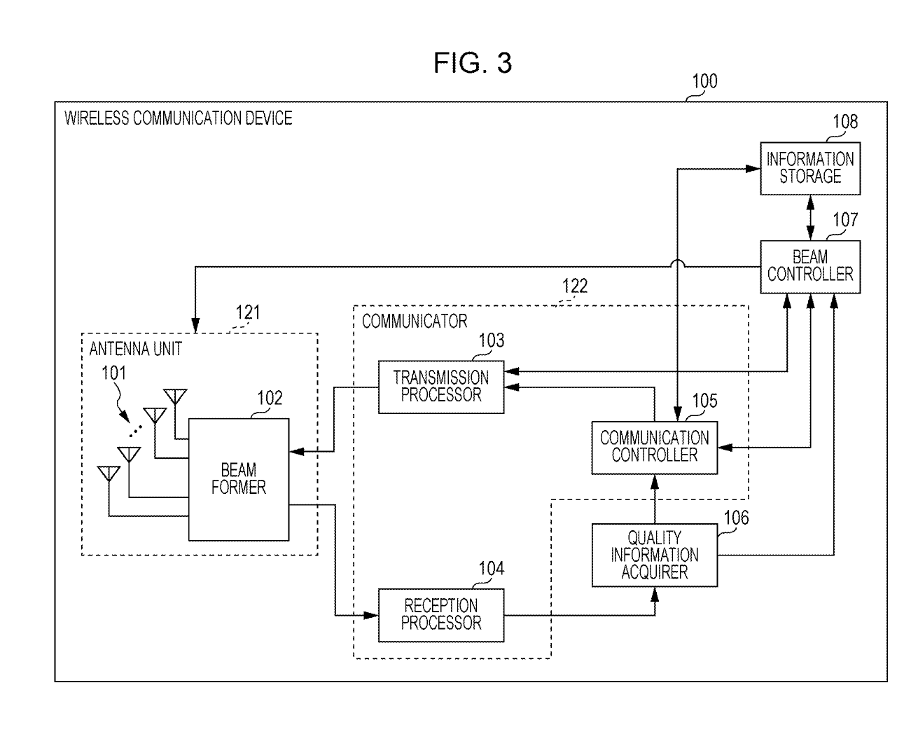

FIG. 3 illustrates an example of a configuration of a wireless communication device 100 according to a first embodiment. In the following, an example in which the wireless communication device 100 caries out millimeter-wave communication with a wireless communication device 200, which serves as a communicating party, will be described. The configuration of the wireless communication device 200 is similar to that of the wireless communication device 100 described hereinafter, and thus detailed descriptions thereof will be omitted.

The wireless communication device 100 includes a plurality of antenna elements 101, a beam former 102, a transmission processor 103, a reception processor 104, a communication controller 105, a quality information acquirer 106, a beam controller 107, and an information storage 108.

The plurality of antenna elements 101 are array antennas arrayed in a predetermined arrangement.

The beam former 102 excites the plurality of antenna elements 101 and controls the amplitude and the phase of an excitation current in order to form a beam for transmitting or receiving a wireless signal, under the control of the beam controller 107, which will be described later.

The plurality of antenna elements 101 and the beam former 102 will collectively be referred to as an antenna unit 121, as appropriate. Specifically, the antenna unit 121 switches the directions of the respective beams by using the plurality of antenna elements 101. In the present embodiment, the antenna unit 121 includes a transmitting antenna and a receiving antenna, and a substantially identical beam pattern can be obtained in each beam direction.

The transmission processor 103 modulates various control signals including a training signal used in BFT and various pieces of information to be transmitted into millimeter-wave signals and transmits the millimeter-wave signals via the antenna unit 121.

The reception processor 104 demodulates, from a millimeter-wave signal received by the antenna unit 121, information included in the millimeter-wave signal. Such information includes various control signals including a received training signal and various pieces of information.

The communication controller 105 generates a packet for communicating with the wireless communication device 200. The communication controller 105 receives information from the quality information acquirer 106, which will be described later, and carries out processing of incorporating, into a packet, information on the best beam direction for communicating with the wireless communication device 200, for example. The transmission processor 103, the reception processor 104, and the communication controller 105 will collectively be referred to as a communicator 122, as appropriate. Specifically, the communicator 122 carries out wireless communication with the wireless communication device 200 by using the antenna unit 121.

In the BFT, the quality information acquirer 106 calculates the reception quality (e.g., the received signal strength indicator (RSSI) and the signal-to-noise ratio (SNR)) of the signal received from the wireless communication device 200 via the communicator 122 and acquires the calculated reception quality as quality information. The quality information is the reception quality, in the wireless communication device 100, of the signal transmitted from the wireless communication device 200. The quality information acquirer 106 may transmit the quality information indicating the reception quality in the wireless communication device 100 to the wireless communication device 200 via the communicator 122 or may receive the quality information indicating the reception quality in the wireless communication device 200 from the wireless communication device 200 via the communicator 122.

In addition, the quality information acquirer 106 functions as a determiner that calculates the reception quality of each training signal transmitted by the wireless communication device 200 and determines the beam number with the highest reception quality. The quality information acquirer 106 outputs the determined beam number to the communication controller 105.

The beam controller 107 controls the beam formed by the antenna unit 121. For example, in the BFT, in response to an instruction from the quality information acquirer 106, the beam controller 107 causes the antenna unit 121 to successively form narrowly directional beams in respective directions and also causes the antenna unit 121 to form a widely directional beam. Then, upon the completion of the BFT, the beam controller 107 forms a narrowly directional beam in the direction determined to be the best (the best beam) and starts data communication.

In addition, the beam controller 107 outputs an instruction to the antenna unit 121 directing the antenna unit 121 to form a narrowly directional transmission beam used in the previous instance of communication (i.e., the best beam of the previous instance) on the basis of the beam direction information stored in the information storage 108, which will be described later. The instruction for the beam formation is implemented in conjunction with an instance in which the communication controller 105 outputs, to the transmission processor 103, an instruction for transmitting a feedback signal including the beam number output from the quality information acquirer 106, for example.

The information storage 108 stores the best beam direction information up to the current moment of the wireless communication device 100 and the wireless communication device 200. The information storage 108 may store the beam direction information used in the entire instances of communication up to the current moment. The beam controller 107 uses the information in the information storage 108 when comparing the best beam direction up to the current moment with the current best beam direction.

The wireless communication device 100 includes, for example, a central processing unit (CPU), a storage medium such as a read-only memory (ROM) storing a control program, a work memory such as a random-access memory (RAM), and a communication circuit. The functions of the components described above are implemented as the CPU executes the control program. In a similar manner, the wireless communication device 200 includes, for example, a CPU, a storage medium such as a ROM storing a control program, a work memory such as a RAM, and a communication circuit. In this case, the functions of the components described above are implemented as the CPU executes the control program.

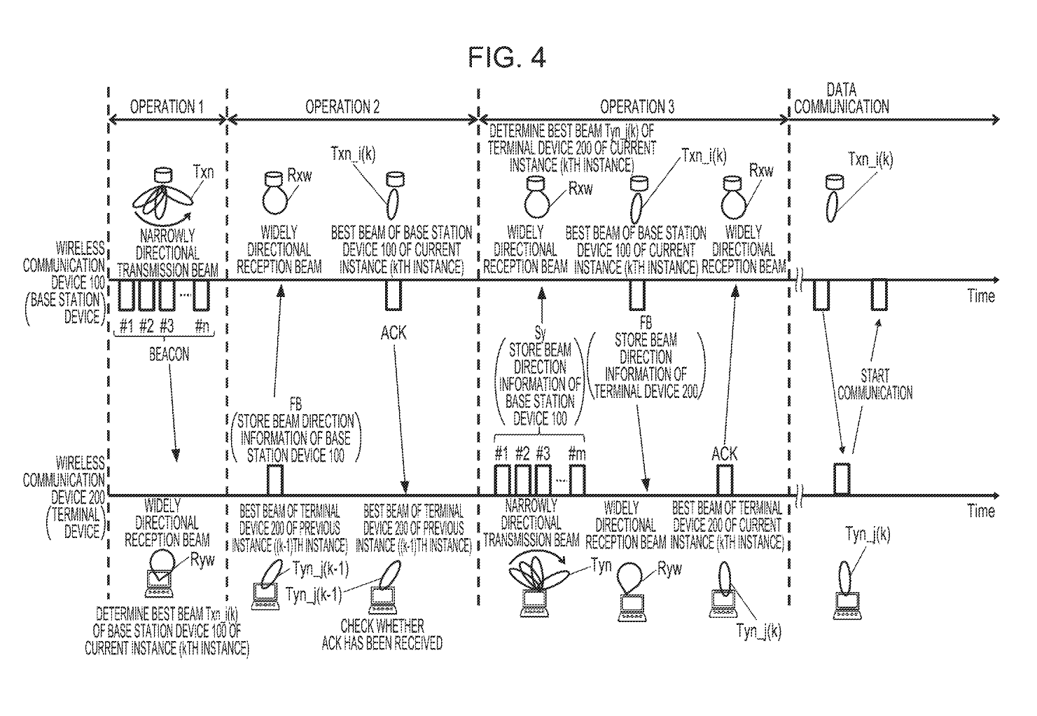

Next, a series of operations of the wireless communication device 100 and the wireless communication device 200 according to the first embodiment will be described with reference to FIG. 4.

FIG. 4 is a sequence diagram illustrating an example of a series of operations according to the first embodiment. In the following, a case in which the wireless communication device 100 is a base station device (referred to as a base station device 100 for convenience) and the wireless communication device 200 is a terminal device (referred to as a terminal device 200 for convenience) will be described.

The base station device 100 and the terminal device 200 carry out BFT similar to the one of the existing techniques described with reference to FIG. 1A to FIG. 1D and FIG. 2 in the initial instance of connection (when the link is established therebetween). Thereafter, in place of the second and subsequent instances of periodic BFT, the base station device 100 and the terminal device 200 carry out the BFT operation according to the first embodiment described hereinafter. The BFT operation according to the first embodiment described hereinafter is a kth instance of BFT operation (k is an integer no smaller than 2), and the terminal device 200 retains the information on the narrowly directional transmission beam that the terminal device 200 has used in data communication after the (k−1)th instance (i.e., the previous instance) of BFT operation (hereinafter, referred to as the best beam of the terminal device 200 of the previous instance ((k−1)th instance).

The best beam of the terminal device 200 of the previous instance refers to the best narrowly directional transmission beam set by the terminal device 200 prior to the current instance of BFT operation.

In FIG. 4, a series of BFT operations according to the first embodiment includes an operation 1, an operation 2, and an operation 3. Although the details will be given later, in the series of BFT operations according to the first embodiment, the base station device 100 and the terminal device 200 may start data communication without carrying out the operation 3, depending on the conditions. Hereinafter, each of the operations will be described.

### Operation 1

In the operation 1, the terminal device 200 determines the best beam of the base station device 100 of the current instance.

In the operation 1, the base station device 100 periodically transmits a beacon, as in the existing techniques (e.g., IEEE 802.11ad-2012 standard, Dec. 28, 2012). The base station device 100 transmits beacons while switching the beam direction of the narrowly directional transmission beam Txn among a plurality of beam directions. The beacons transmitted with the use of the transmission beam Txn in the respective beam directions include the identification information of the corresponding beam directions.

The terminal device 200 receives a plurality of beacons transmitted from the base station device 100 by using the widely directional reception beam Ryw, as the terminal device 200 knows the transmission interval of the beacons transmitted from the base station device 100. Then, the terminal device 200 calculates the reception quality of each beam direction and determines the best beam for the base station device 100 to communicate with the terminal device 200 (the best beam). For example, the terminal device 200 determines the beam with the highest reception quality, among the reception qualities of the respective beam directions, as the best beam. The determined best beam is the best beam of the base station device 100 of the current instance (kth instance).

### Operation 2

In the operation 2, the base station device 100 is notified of the information on the best beam of the base station device 100 of the current instance determined by the terminal device 200 in the operation 1, and whether the best beam used by the terminal device 200 in the previous instance of data communication can continue to be used in the current instance of data communication is checked.

In the operation 2, the terminal device 200 transmits, to the base station device 100, a feedback signal (hereinafter, abbreviated to FB) by using the best beam (Tyn_j(k−1)) of the terminal device 200 of the previous instance ((k−1)th instance). The FB stores the beam direction information indicating the best beam of the base station device 100 of the current instance (kth instance) determined in the operation 1.

For the FB, a sector sweep feedback frame described in IEEE 802.1 lad-2012 standard, Dec. 28, 2012, may be used, for example.

The base station device 100 determines whether the base station device 100 has received the FB from the terminal device 200 by using the widely directional reception beam Rxw. Then, if the base station device 100 has received the FB, the base station device 100 sets the best beam (Txn_i(k)) of the base station device 100 of the current instance (kth instance) indicated by the beam direction information stored in the FB as the beam to be used in the current instance of data communication. Then, the base station device 100 transmits, to the terminal device 200, an acknowledgement (ACK) by using the set best beam (Txn_i(k)) of the base station device 100 of the current instance (kth instance).

If the terminal device 200 has received the ACK by using the best beam (Tyn_j(k−1)) of the previous instance, the base station device 100 and the terminal device 200 start data communication without carrying out the operation 3.

If the terminal device 200 has received the ACK from the base station device 100 by using the best beam (Tyn_j(k−1)) of the previous instance, this suggests that the FB transmitted by the terminal device 200 by using the best beam (Tyn_j(k−1)) of the previous instance has been received by the base station device 100 and the received ACK satisfies the reception quality in the data communication. In other words, the terminal device 200 can confirm that the terminal device 200 can communicate with the base station device 100 by using the best beam (Tyn_j(k−1)) of the previous instance, and thus the base station device 100 and the terminal device 200 can start data communication without carrying out the operation of determining the best beam of the terminal device 200 again by transmitting and receiving training signals.

In a case in which the terminal device 200 does not carry out data communication after receiving the ACK by using of the best beam (Tyn_j(k−1)) of the previous instance, the terminal device 200 may set the widely directional reception beam Ryw to receive a subsequent beacon transmitted from the base station device 100 (i.e., to carry out the next instance of operation 1). The terminal device 200 may carry out an operation such as turning off the power source or entering a sleep state, for example, until the timing of receiving the beacon.

On the other hand, if the terminal device 200 has received no ACK by using the best beam (Tyn_j(k−1)) of the previous instance or if the terminal device 200 has received the ACK but the reception quality in the data communication is not satisfied, the base station device 100 and the terminal device 200 carry out the operation 3.

If the terminal device 200 has received no ACK by using the best beam (Tyn_j(k−1)) of the previous instance, this suggests, for example, that the FB from the terminal device 200 has failed to reach the base station device 100, that the terminal device 200 has had difficulty receiving the ACK from the base station device 100, or that the reception quality in the data communication is not satisfied. In other words, the terminal device 200 determines that it is difficult to communicate with the base station device 100 with the best beam (Tyn_j(k−1)) of the previous instance and carries out the operation 3 of determining the best beam of the terminal device 200.

The base station device 100 and the terminal device 200 carry out the operation 3 in a case in which the FB does not reach the base station device 100 or it is difficult to receive the ACK from the base station device 100 due to an influence of interference, for example, even though the best beam (Tyn_j(k−1)) of the terminal device 200 of the previous instance satisfies the reception quality in the data communication with the base station device 100 in the operation 2.

### Operation 3

In the operation 3, the base station device 100 determines the best beam of the terminal device 200 of the current instance and notifies the terminal device 200 of the information on the determined best beam.

In the operation 3, the terminal device 200 transmits the training signals Sy to the base station device 100 by using the narrowly directional transmission beams Tyn in the respective beam directions while switching the beam direction of the transmission beam Tyn among a plurality of beam directions. The training signals Sy store the beam direction information indicating the best beam of the base station device 100 of the current instance (kth instance) determined in the operation 1.

The training signal may also be referred to as a BFT packet. For the training signal, a sector sweep feedback frame described in IEEE 802.11 lad-2012 standard, Dec. 28, 2012, may be used.

The base station device 100 receives the training signals Sy transmitted from the terminal device 200 by using the widely directional reception beam Rxw. The base station device 100 calculates the reception quality of each beam direction and determines the best beam for the terminal device 200 to communicate with the base station device 100. For example, the base station device 100 determines the beam with the highest reception quality, among the reception qualities of the respective beam directions, as the best beam. The determined best beam is the best beam of the terminal device 200 of the current instance (kth instance).

Then, the base station device 100 sets the best beam (Txn_i(k)) of the base station device 100 of the current instance (kth instance) indicated by the beam direction information stored in the training signal Sy as the beam to be used in the current instance of data communication. Then, the base station device 100 transmits an FB to the terminal device 200. The FB stores the beam direction information indicating the best beam of the terminal device 200 of the current instance (kth instance).

The terminal device 200 receives the FB by using the widely directional reception beam Ryw. Then, the terminal device 200 sets the best beam (Tyn_j(k)) of the terminal device 200 of the current instance (kth instance) indicated by the beam direction information stored in the FB as the beam to be used in the current instance of data communication. Then, the terminal device 200 transmits an ACK to the base station device 100 by using the set best beam (Tyn_j(k)) of the terminal device 200 of the current instance.

Upon the base station device 100 having received the ACK by using the widely directional reception beam Rxw, the base station device 100 and the terminal device 200 start data communication.

In the operation 3, if a predetermined period of time has passed while the base station device 100 receives no training signal Sy or if a predetermined period of time has passed while the terminal device 200 receives no FB due to an influence of interference, for example, the terminal device 200 may transmit a training signal Sy again or may wait for a subsequent beacon to be transmitted from the base station device 100 (i.e., the subsequent instance of operation 1).

In addition, in the operation 3, if the base station device 100 receives no ACK due to an influence of interference, for example, the base station device 100 and the terminal device 200 may start data communication without transmitting and receiving training signals again. This is because the best beam is established for each of the base station device 100 and the terminal device 200.

In the BFT operation illustrated in FIG. 4, if data communication is omitted, the terminal device 200 may set the widely directional reception beam and stand by until the transmission timing of the next beacon or may turn off the power source or enter the sleep state until the transmission timing of the next beacon.

As described thus far, the series of operations in the BFT according to the first embodiment takes different operation patterns depending on the condition as to whether the beam direction to be used in the communication is to be changed. Hereinafter, the relationship between whether the beam direction needs to be changed in the base station device 100 and the terminal device 200 and the operation pattern will be described.

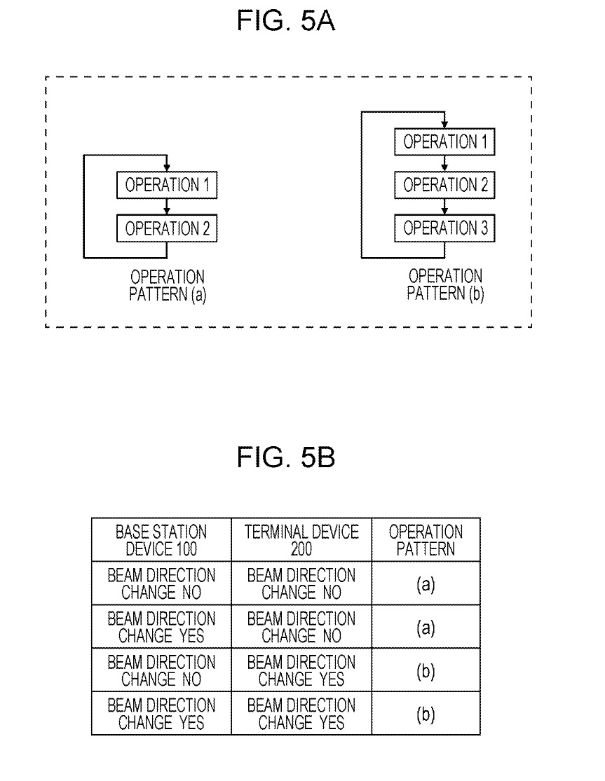

FIG. 5A illustrates examples of the operation patterns according to the first embodiment. FIG. 5B illustrates the correspondence of the operation patterns illustrated in FIG. 5A with the base station device 100 and the terminal device 200. FIG. 5A illustrates an operation patter (a) in which the operation 1 and the operation 2 illustrated in FIG. 4 are carried out in sequence and an operation pattern (b) in which the operation 1, the operation 2, and the operation 3 are carried out in sequence. FIG. 5B illustrates the correspondence relationship between whether each of the base station device 100 and the terminal device 200 changes the beam direction used in the communication and either of the operation pattern (a) and the operation patter (b).

The expression “the base station device 100 changes the beam direction used in the communication” corresponds, for example, to a case in which the position of the terminal device 200 changes as the terminal device 200 moves. In addition, the expression “the terminal device 200 changes the beam direction used in the communication” corresponds, for example, to a case in which the posture or the orientation of the terminal device 200 changes.

In FIG. 5B, if the terminal device 200 does not change the beam direction used in the communication (beam direction change in terminal device 200: NO), the operations indicated in the operation pattern (a) are carried out regardless of whether the base station device 100 changes the beam direction used in the communication. In the operation pattern (a), as the operations 1 and 2 are carried out, it can be determined whether the terminal device 200 changes the beam direction used in the communication.

On the other hand, if the terminal device 200 changes the beam direction used in the communication (beam direction change in terminal device 200: YES), regardless of whether the base station device 100 changes the beam direction used in the communication, the operations indicated in the operation pattern (b) are carried out, and the best beam of the terminal device 200 is determined in the operation 3.

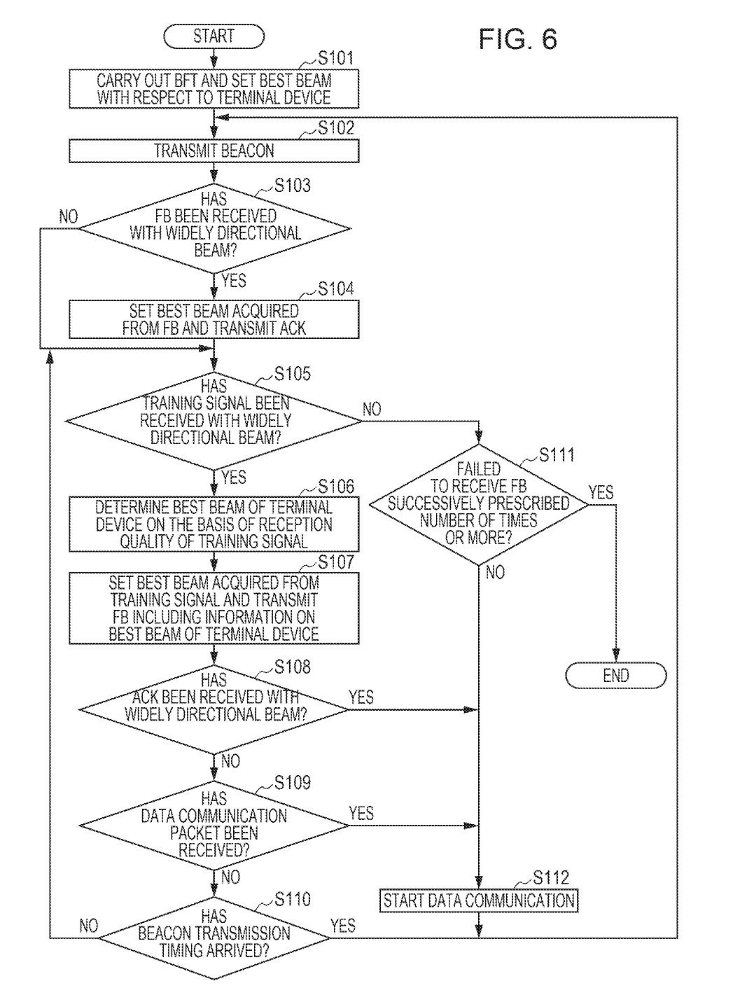

Next, the flow of the base station device 100 according to the first embodiment will be described with reference to FIG. 6. FIG. 6 is a flowchart illustrating the processing of the base station device 100 according to the first embodiment. FIG. 6 illustrates step S101 to step S112.

In step S101, the communication controller 105 of the base station device 100 carries out, for example, the BFT illustrated in FIG. 2 between the base station device 100 and the terminal device 200, establishes a link connection with the terminal device 200, and sets the best beam to be used in the communication with the terminal device 200.

In step S102, the base station device 100 transmits a beacon while switching the beam direction of the narrowly directional beam.

The communication controller 105 outputs an instruction to the transmission processor 103 directing the transmission processor 103 to transmit a beacon frame. The transmission processor 103 appends the beam number to each beacon frame. The transmission processor 103 transmits the beacons at a predetermined time interval via the antenna unit 121 by using the narrowly directional beams corresponding to the respective beam numbers under the control of the beam controller 107.

In step S103, the base station device 100 determines whether the base station device 100 has received an FB from the terminal device 200 by using a widely directional beam.

The beam controller 107 of the base station device 100 instructs the antenna unit 121 to form a widely directional reception beam. The antenna unit 121 forms a widely directional reception beam and stands by until the antenna unit 121 receives an FB from the terminal device 200. Then, the reception processor 104 determines whether the reception processor 104 has received an FB from the terminal device 200 via the antenna unit 121.

If the base station device 100 has received no FB from the terminal device 200 (NO in step S103), the flow proceeds to the processing in step S105.

If the base station device 100 has received an FB from the terminal device 200 (YES in step S103), in step S104, the base station device 100 sets the best beam of the base station device 100 of the current instance indicated by the beam direction information included in the FB. The base station device 100 transmits an ACK by using the set best beam.

The quality information acquirer 106 acquires the beam direction information of the base station device 100 included in the FB and outputs the beam direction information to the beam controller 107. The beam controller 107 sets the best beam indicated by the beam direction information into the antenna unit 121. Upon having acquired the FB from the quality information acquirer 106, the communication controller 105 outputs an instruction to the transmission processor 103 directing the transmission processor 103 to transmit an ACK to the terminal device 200. The transmission processor 103 transmits an ACK via the antenna unit 121.

In step S105, the base station device 100 determines whether the base station device 100 has received a training signal from the terminal device 200 by using a widely directional beam.

The beam controller 107 of the base station device 100 instructs the antenna unit 121 to form a widely directional reception beam. The antenna unit 121 forms a widely directional reception beam and stands by until the antenna unit 121 receives a training signal from the terminal device 200. The reception processor 104 determines whether the reception processor 104 has received a training signal from the terminal device 200 via the antenna unit 121.

If the base station device 100 has received no training signal from the terminal device 200 (NO in step S105), in step S111, the base station device 100 determines whether the base station device 100 has failed to receive an FB (of the following ((k+1)th instance) and subsequent instances) from the terminal device 200 successively a prescribed number of times. This is for the base station device 100 to determine whether the terminal device 200 is outside the communicable range of the base station device 100.

In step S111, if the base station device 100 has failed to receive an FB transmitted from the terminal device 200 successively a prescribed number of times or more (YES in step S111), the base station device 100 determines that the link between the base station device 100 and the terminal device 200 has been disconnected, and the base station device 100 terminates the processing with the terminal device 200.

In step S111, if the base station device 100 has received an FB from the terminal device 200 within a prescribed number of times (NO in step S111), in step S112, the base station device 100 starts data communication with the terminal device 200. The data communication continues until the transmission timing of the next beacon.

If the base station device 100 has received a training signal from the terminal device 200 (YES in step S105), in step S106, the base station device 100 determines the best beam of the terminal device 200 of the current instance on the basis of the reception quality of the received training signal.

The quality information acquirer 106 calculates the reception quality of each training signal transmitted by the terminal device 200, determines the beam number with the highest reception quality, and outputs the determined beam number to the communication controller 105.

In step S107, the base station device 100 sets the best beam of the base station device 100 of the current instance indicated b the beam direction information included in the training signal. Then, the base station device 100 transmits an FB including the information indicating the best beam of the terminal device 200 of the current instance determined in step S106.

Specifically, the quality information acquirer 106 acquires the beam direction information of the base station device 100 included in the training signal and outputs the beam direction information to the beam controller 107. The beam controller 107 sets the best beam indicated by the beam direction information into the antenna unit 121. Upon having acquired the beam direction information indicating the best beam of the terminal device 200 of the current instance from the quality information acquirer 106, the communication controller 105 outputs an instruction to the transmission processor 103 directing the transmission processor 103 to transmit an FB to the terminal device 200. The transmission processor 103 transmits an FB including the beam direction information of the terminal device 200 via the antenna unit 121.

In step S108, the base station device 100 determines whether the base station device 100 has received an ACK from the terminal device 200 by using a widely directional beam.

Specifically, the beam controller 107 of the base station device 100 instructs the antenna unit 121 to form a widely directional reception beam. The antenna unit 121 forms a widely directional reception beam and stands by until the antenna unit 121 receives an ACK from the terminal device 200. Then, the reception processor 104 determines whether the reception processor 104 has received an ACK from the terminal device 200 via the antenna unit 121.

If the base station device 100 has received an ACK (YES in step S108), in step S112, the base station device 100 starts data communication with the terminal device 200. The data communication continues until the transmission timing of the next beacon.

If the base station device 100 has received no ACK (NO in step S108), in step S109, the base station device 100 determines whether the base station device 100 has received a data communication packet from the terminal device 200.

If the base station device 100 has received a data communication packet (YES in step S109), in step S112, the base station device 100 starts data communication with the terminal device 200. The data communication continues until the transmission timing of the next beacon.

If the base station device 100 has received no data communication packet (NO in step S109), in step S110, the base station device 100 determines whether the transmission timing of the next beacon has arrived.

If the base station device 100 determines that the beacon transmission timing has arrived (YES in step S110), the flow returns to the processing in step S102. If the base station device 100 determines that the beacon transmission timing has not arrived (NO in step S110), the flow returns to the processing in step S105.

In step S112 described above, the base station device 100 may stand by until the transmission timing of the next beacon if the base station device 100 does not carry out data communication with the terminal device 200.

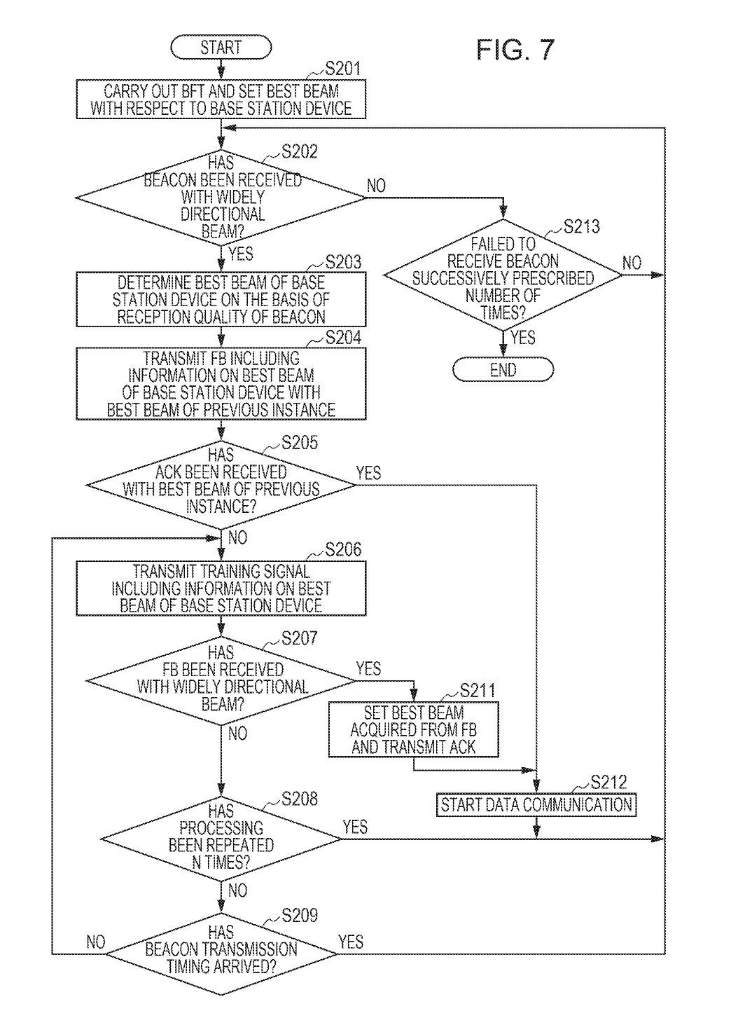

Next, the flow of the terminal device 200 according to the first embodiment will be described with reference to FIG. 7. FIG. 7 is a flowchart illustrating the processing of the terminal device 200 according to the first embodiment. FIG. 7 illustrates step S201 to step S213.

In step S201, the communication controller 105 of the terminal device 200 carries out, for example, the BFT illustrated in FIG. 2 between the terminal device 200 and the base station device 100, establishes a link connection with the base station device 100, and sets the best beam to be used in the communication with the base station device 100.

In step S202, the terminal device 200 determines whether the terminal device 200 has received a beacon from the base station device 100 by using a widely directional beam.

The beam controller 107 of the terminal device 200 instructs the antenna unit 121 to form a widely directional reception beam. The antenna unit 121 forms a widely directional reception beam and stands by until the terminal device 200 receives a beacon from the base station device 100. Then, the reception processor 104 determines whether the reception processor 104 has received a beacon from the base station device 100 via the antenna unit 121.

If the terminal device 200 has received no beacon from the base station device 100 (NO in step S202), it is highly likely that the terminal device 200 is outside the communicable range of the base station device 100. Therefore, in step S213, the terminal device 200 determines whether the terminal device 200 has failed to receive a beacon successively a prescribed number of times or more.

If the terminal device 200 determines that the number of times the terminal device 200 has failed to receive a beacon from the base station device 100 is less than the prescribed number of times (NO in step S213), the flow returns to the processing in step S202.

If the terminal device 200 determines that the number of times the terminal device 200 has failed to receive a beacon from the base station device 100 is no smaller than the prescribed number of times (YES in step S213), the terminal device 200 determines that the terminal device 200 has moved outside the connectable range of the base station device 100 and terminates the processing with the base station device 100 in the terminal device 200.

If the terminal device 200 has received a beacon from the base station device 100 (YES in step S202), in step S203, the terminal device 200 determines the best beam of the base station device 100 of the current instance on the basis of the reception quality of the received beacon.

The quality information acquirer 106 calculates the reception quality of the beacon transmitted by the base station device 100, determines the beam number with the highest reception quality, and outputs the determined beam number to the communication controller 105.

In step S204, the terminal device 200 transmits an FB including the information indicating the best beam of the base station device 100 of the current instance determined in step S203 by using the best beam of the previous instance.

Upon having acquired the beam direction information indicating the best beam of the base station device 100 of the current instance from the quality information acquirer 106, the communication controller 105 outputs an instruction to the transmission processor 103 directing the transmission processor 103 to transmit an FB including the beam direction information indicating the best beam of the base station device 100 of the current instance. In addition, upon the communication controller 105 having output an instruction to transmit the FB to the beam controller 107, the beam controller 107 instructs the antenna unit 121 to form a narrowly directional transmission beam used in the previous instance of communication (i.e., the best beam of the previous instance). The antenna unit 121 forms the narrowly directional transmission beam used in the previous instance of communication. Then, the transmission processor 103 transmits the FB via the antenna unit 121.

In step S205, the terminal device 200 determines whether the terminal device 200 has received an ACK from the base station device 100 by using the best beam of the previous instance. If the terminal device 200 determines in step S205 that the terminal device 200 has received an ACK from the base station device 100, the terminal device 200 determines whether the received ACK satisfies the reception quality in the data communication.

Specifically, the beam controller 107 instructs the antenna unit 121 to form a narrowly directional reception beam used in the previous instance of data communication. The antenna unit 121 forms the narrowly directional reception beam used in the previous instance of data communication and stands by until the antenna unit 121 receives an ACK from the base station device 100. The reception processor 104 determines whether the reception processor 104 has received an ACK transmitted by the base station device 100 via the antenna unit 121. If the terminal device 200 has received an ACK from the base station device 100, the quality information acquirer 106 of the terminal device 200 acquires the reception quality of the ACK, and the communication controller 105 of the terminal device 200 determines whether the received ACK satisfies the reception quality in the data communication.

If the terminal device 200 has received an ACK from the base station device 100 and the received ACK satisfies the reception quality in the data communication (YES in step S205), in step S212, the terminal device 200 starts data communication with the base station device 100. The data communication continues until the transmission timing of the next beacon.

If the terminal device 200 has received no ACK from the base station device 100 for a predetermined period of time or if the ACK received by the terminal device 200 does not satisfy the reception quality in the data communication (NO in step S205), in step S206, the terminal device 200 makes a switch to a narrowly directional beam and transmits a training signal including the information indicating the best beam of the base station device 100 of the current instance determined in step S203.

Specifically, the communication controller 105 outputs an instruction to the transmission processor 103 directing the transmission processor 103 to transmit a training signal. The communication controller 105 acquires, from the quality information acquirer 106, the beam direction information indicating the best beam of the base station device 100 of the current instance and outputs the beam direction information to the transmission processor 103. The transmission processor 103 appends the beam number to each training signal including the beam direction information. The transmission processor 103 transmits the training signal periodically via the antenna unit 121 by using the narrowly directional beam corresponding to the beam number under the control of the beam controller 107.

Next, in step S207, the terminal device 200 determines whether the terminal device 200 has received an FB from the base station device 100 by using a widely directional beam.

Specifically, the beam controller 107 of the terminal device 200 instructs the antenna unit 121 to form a widely directional reception beam. The antenna unit 121 forms a widely directional reception beam and stands by until the antenna unit 121 receives an FB from the base station device 100. The reception processor 104 determines whether the reception processor 104 has received an FB from the base station device 100 via the antenna unit 121.

If the terminal device 200 has received an FB from the base station device 100 (YES in step S207), in step S211, the terminal device 200 sets the best beam of the terminal device 200 of the current instance indicated by the beam direction information included in the FB. The terminal device 200 transmits an ACK by using the set best beam.

Specifically, the quality information acquirer 106 acquires the beam direction information of the terminal device 200 included in the FB and outputs the beam direction information to the beam controller 107. The beam controller 107 sets the best beam indicated by the beam direction information into the antenna unit 121. Upon having acquired the FB from the quality information acquirer 106, the communication controller 105 outputs an instruction to the transmission processor 103 directing the transmission processor 103 to transmit an ACK to the terminal device 200. The transmission processor 103 transmits an ACK via the antenna unit 121 by using the set best beam.

In step S212, the terminal device 200 starts data communication with the base station device 100. The data communication continues until the transmission timing of the next beacon.

If the terminal device 200 has received no FB from the base station device 100 (NO in step S207), in step S208, the terminal device 200 determines whether the processing in step S206 and step S207 has been repeated N times.

If the processing in step S206 and step S207 has not been repeated N times (NO in step S208), in step S209, the terminal device 200 determines whether the transmission timing of the next beacon has arrived.

If the transmission timing of the next beacon has not arrived (NO in step S209), the flow returns to the processing in step S206.

If the processing in step S206 and step S207 has been repeated N times (YES in step S208) or if the transmission timing of the next beacon has arrived (YES in step S209), the flow returns to the processing in step S202.

As described thus far, according to the first embodiment, if the terminal device 200 does not change the beam direction, the terminal device 200 can exchange a minimum required control packet with the base station device 100 (the operation 2 in FIG. 4) without transmitting, to the base station device 100, a training signal (Sy) for determining the best beam of the terminal device 200, and the base station device 100 and the terminal device 200 can start data communication. With this configuration, the frequency of transmitting and receiving training signals can be reduced, and thus a decrease in the communication throughput can be suppressed.

In addition, according to the first embodiment, instead of transmitting a training signal for determining the best beam of the base station device 100, the base station device 100 can use a beacon transmitted periodically. With this configuration, the frequency of transmitting and receiving training signals can be further reduced, and thus a decrease in the communication throughput can be suppressed.

### Second Embodiment

In a second embodiment, an example in which a decrease in the throughput can be further suppressed as two BFT operations (a first BFT operation and a second BFT operation) work together in the second and subsequent instances of BFT operations will be described.

The configuration of a wireless communication device according to the second embodiment is similar to the configuration of the wireless communication device 100 according to the first embodiment illustrated in FIG. 3, and thus detailed descriptions thereof will be omitted.

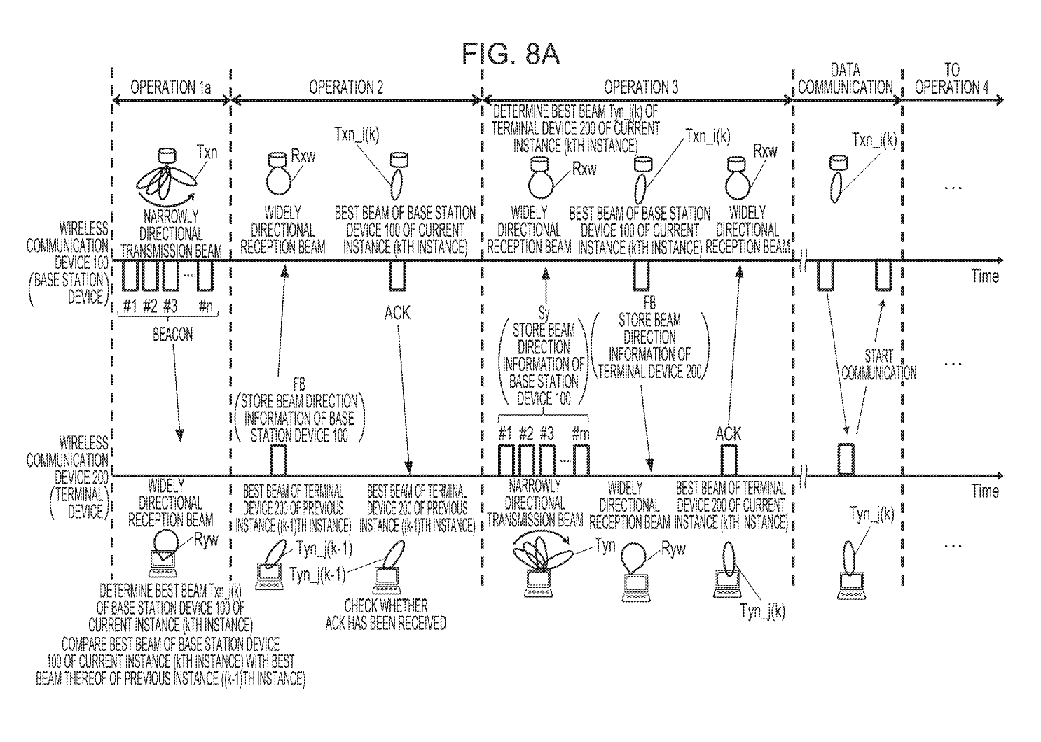

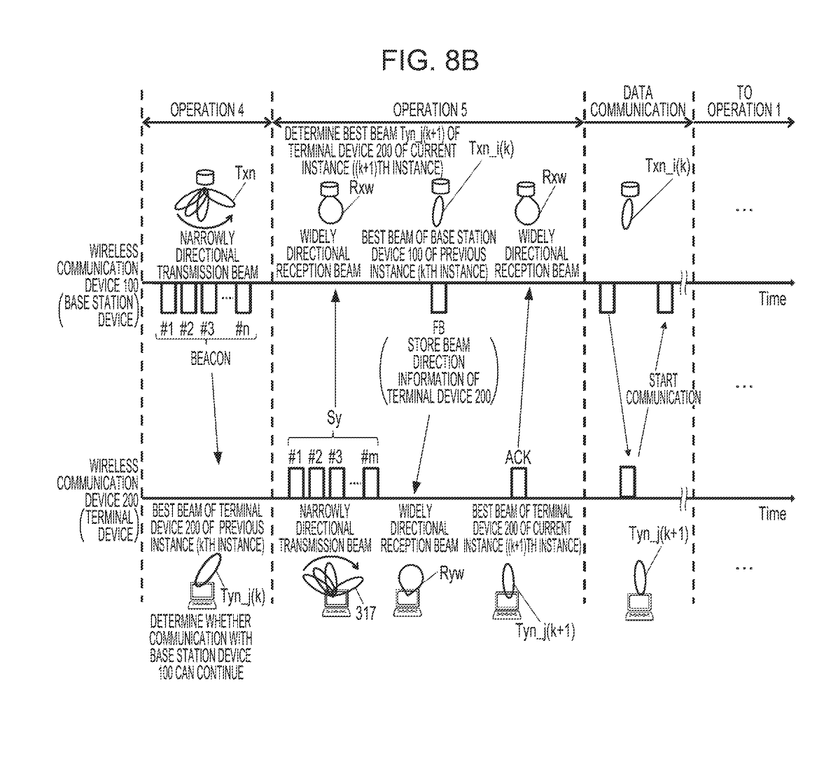

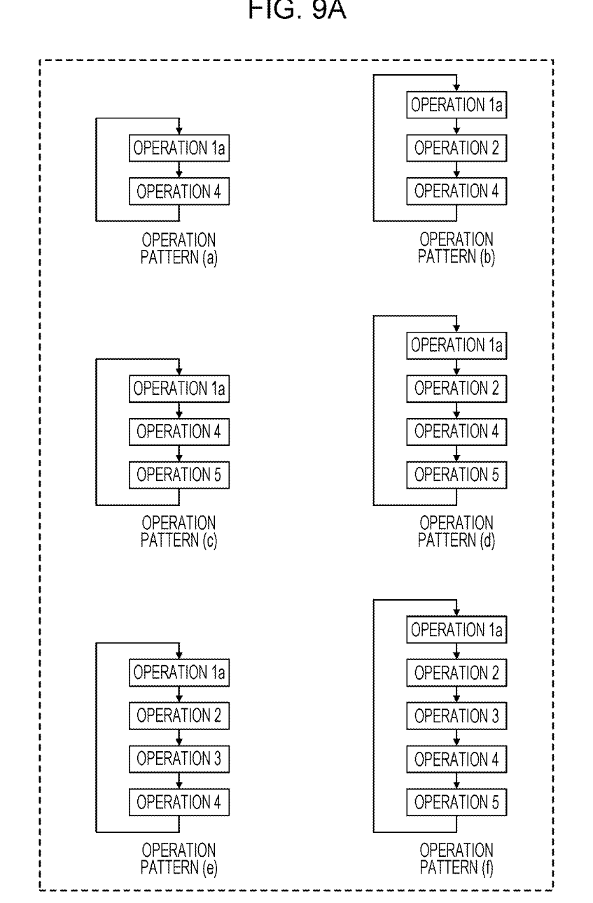

A series of operations of a wireless communication device 100 and another wireless communication device 200 according to the second embodiment will be described with reference to FIG. 8A and FIG. 8B.

FIG. 8A and FIG. 8B are a sequence diagram illustrating an example of a series of operations according to the second embodiment. The BFT operation illustrated in FIG. 8A is a first BFT operation according to the second embodiment, and the BFT operation illustrated in FIG. 8B is a second BFT operation carried out after the first BFT operation illustrated in FIG. 8A. In the following, a case in which the wireless communication device 100 is a base station device (referred to as the base station device 100 for convenience) and the wireless communication device 200 is a terminal device (referred to as the terminal device 200 for convenience) will be described.

The base station device 100 and the terminal device 200 carry out BFT similar to the one in the existing techniques illustrated in FIG. 1A to FIG. 1D and FIG. 2 in an initial connection (when the link is established therebetween). Thereafter, in place of the second and subsequent instances of periodic BFT, the base station device 100 and the terminal device 200 carry out the BFT operation according to the second embodiment described hereinafter. Hereinafter, for the sake of description, the first BFT operation illustrated in FIG. 8A is a kth instance of BFT operation (k is an integer no smaller than 2), and the second BFT operation illustrated in FIG. 8B is a (k+1)th instance of BFT operation. It is to be noted that either of the operations illustrated in FIG. 8A and FIG. 8B can be carried out first. In that case, the BFT carried out first is the first BFT operation (kth instance of BFT operation). The base station device 100 and the terminal device 200 each retain the information on the best beam of the previous instance.

The first BFT operation illustrated in FIG. 8A includes an operation 1a, an operation 2, and an operation 3. Although the details will be given later, in the first BFT operation according to the second embodiment, the base station device 100 and the terminal device 200 can start data communication without carrying out the operation 3 or without carrying out the operation 2 and the operation 3, depending on the conditions.

The second BFT operation illustrated in FIG. 8B includes an operation 4 and an operation 5. Although the details will be given later, in the second BFT operation according to the second embodiment, the base station device 100 and the terminal device 200 can start data communication without carrying out the operation 5, depending on the conditions.

First, the first BFT operation illustrated in FIG. 8A will be described. The operation 1a in the first BFT operation is different from the operation 1 in the BFT operation according to the first embodiment illustrated in FIG. 4.

### Operation 1a

In the operation 1a, the terminal device 200 determines the best beam of the base station device 100 of the current instance and checks whether the best beam used by the base station device 100 in the previous instance of data communication can continue to be used in the current instance of data communication.

In the operation 1a, the base station device 100 periodically transmits a beacon, as in the existing techniques (e.g., IEEE 802.11ad-2012 standard, Dec. 28, 2012). In a similar manner to the first embodiment, a beacon is used in the second embodiment. The base station device 100 transmits a beacon by using narrowly directional transmission beams Txn in respective beam directions while switching the beam direction of the transmission beam Txn among a plurality of beam directions. The beacons transmitted with the use of the transmission beams Txn in the respective beam directions include the identification information of the corresponding beam directions.

The terminal device 200 receives a plurality of beacons transmitted from the base station device 100 by using a widely directional reception beam Ryw, as the terminal device 200 knows the transmission interval of the beacons transmitted from the base station device 100. Then, the terminal device 200 calculates the reception quality of each beam direction and determines the best beam for the base station device 100 to communicate with the terminal device 200 (the best beam). For example, the terminal device 200 determines the beam with the highest reception quality, among the reception qualities of the respective beam directions, as the best beam. The determined best beam is the best beam of the base station device 100 of the current instance (kth instance).

The terminal device 200 compares the best beam of the base station device 100 of the current instance (kth instance) with the best beam of the base station device 100 of the previous instance ((k−1)th instance).

If the result of the comparison indicates that the best beam of the base station device 100 of the current instance (kth instance) is identical to the best beam of the base station device 100 of the previous instance ((k−1)th instance), the base station device 100 and the terminal device 200 start data communication without carrying out the operation 2 and the operation 3.

If the result of the comparison indicates that the best beam of the base station device 100 of the current instance (kth instance) is not identical to the best beam of the base station device 100 of the previous instance ((k−1)th instance), the base station device 100 and the terminal device 200 carry out the operation 2.

The operation 2 and the operation 3 in the first BFT operation are similar to the operation 2 and the operation 3 in the BFT operation according to the first embodiment illustrated in FIG. 4, and thus detailed descriptions thereof will be omitted.

Next, the operation 4 and the operation 5 included in the second BFT operation illustrated in FIG. 8B will be described.

Operation 4

In the operation 4, whether the best beam used by the terminal device 200 in the previous instance of data communication continues to be used in the current instance of data communication is checked.

In a similar manner to the operation 1a, in the operation 4, the base station device 100 transmits a beacon.

The terminal device 200 receives a plurality of beacons transmitted from the base station device 100 by using the best beam (Tyn_j(k)) of the terminal device 200 of the previous instance (i.e., the kth instance). Then, the terminal device 200 calculates the reception quality of the beacon, among the plurality of received beacons, that the base station device 100 has transmitted by using the best beam of the base station device 100 of the previous instance and compares the calculated reception quality against a predetermined threshold value to determine whether the calculated reception quality satisfies the reception quality in the data communication.

The best beam of the base station device 100 of the previous instance refers to the best narrowly directional transmission beam set by the base station device 100 prior to the current instance of BFT operation.

If the calculated reception quality is no lower than the threshold value, the terminal device 200 determines to continue with the communication with the base station device 100 by using the best beam of the terminal device 200 of the previous instance. If the terminal device 200 continues with the communication with the base station device 100 by using the best beam of the terminal device 200 of the previous instance, the terminal device 200 and the base station device 100 start data communication without carrying out the operation 5.

If the calculated reception quality is lower than the threshold value, the terminal device 200 determines not to continue with the communication with the base station device 100 by using the best beam of the terminal device 200 of the previous instance. If the terminal device 200 does not continue with the communication with the base station device 100 by using the best beam of the terminal device 200 of the previous instance, the terminal device 200 carries out the operation 5 in order to determine the best beam of the terminal device 200 of the current instance (i.e., (k+1)th instance).

### Operation 5

In the operation 5, the base station device 100 determines the best beam of the terminal device 200 of the current instance and notifies the terminal device 200 of the information on the determined best beam.

In the operation 5, the terminal device 200 transmits training signals Sy by using narrowly directional transmission beams Tyn of respective beam directions while switching the beam direction of the transmission beam Tyn among a plurality of beam directions.

The base station device 100 receives the training signals Sy transmitted from the terminal device 200 by using a widely directional reception beam Rxw.

The base station device 100 calculates the reception quality of each beam direction and determines the best beam for the terminal device 200 to use to communicate with the base station device 100. For example, the base station device 100 determines the beam with the highest reception quality, among the reception qualities of the respective beam directions, as the best beam. The determined best beam is the best beam of the terminal device 200 of the current instance ((k+1)th instance).

Then, the base station device 100 sets the best beam (Txn_i(k)) of the base station device 100 of the previous instance (kth instance). Then, the base station device 100 transmits an FB to the terminal device 200. The FB stores the beam direction information indicating the best beam of the terminal device 200 of the current instance ((k+1)th instance).

The terminal device 200 receives the FB from the base station device 100 by using a widely directional reception beam Ryw. Then, the terminal device 200 sets the best beam (Tyn_j(k+1)) of the terminal device 200 of the current instance ((k+1)th instance) indicated by the beam direction information stored in the FB. Then, the terminal device 200 transmits an ACK to the base station device 100.

If the base station device 100 has received the ACK by using a widely directional reception beam Rxw, the base station device 100 and the terminal device 200 start data communication.

In the operation 3, if a predetermined period of time has passed while the base station device 100 receives no training signal Sy or if a predetermined period of time has passed while the terminal device 200 receives no FB due to an influence of interference, for example, the terminal device 200 may transmit a training signal Sy again or may wait for the next beacon to be transmitted from the base station device 100 (i.e., the operation 4). In a similar manner, in the operation 5, if a predetermined period of time has passed while the base station device 100 receives no training signal Sy or if a predetermined period of time has passed while the terminal device 200 receives no FB due to an influence of interference, for example, the terminal device 200 may transmit a training signal Sy again or may wait for the next beacon to be transmitted from the base station device 100 (i.e., the subsequent instance of operation 1a).

In the BFT operation illustrated in FIG. 8A and FIG. 8B, if the data communication is omitted, the terminal device 200 may set a widely directional reception beam and stand by until the transmission timing of the next beacon or may turn off the power source or enter the sleep state until the transmission timing of the next beacon.

As described thus far, the series of operations of the BFT according to the second embodiment take different operation patterns depending on the condition for determining as to whether the beam direction to be used in the communication is to be changed. Hereinafter, the relationship between whether the beam direction needs to be changed in the base station device 100 and the terminal device 200 and the operation patterns will be described.

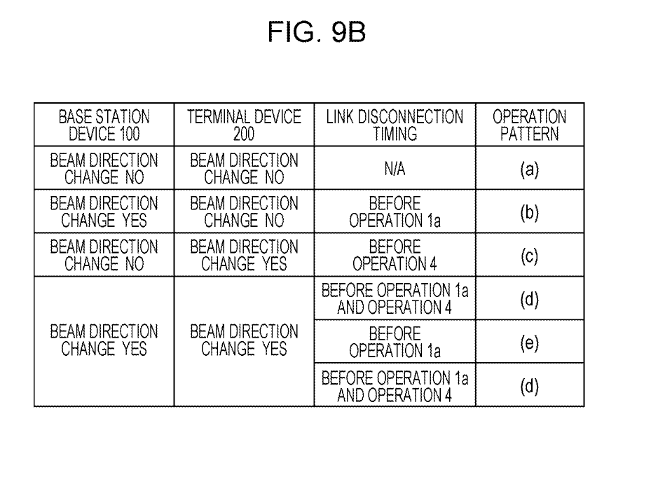

FIG. 9A illustrates operation patterns according to the second embodiment. FIG. 9A illustrates an operation pattern (a) to an operation pattern (f) expressed by combinations of the operation 1a to the operation 5 illustrated in FIG. 8A and FIG. 8B. FIG. 9B illustrates a correspondence of the operation patterns illustrated in FIG. 9A with the base station device 100, the terminal device 200, and a link disconnecting timing.

In FIG. 9B, if neither the base station device 100 nor the terminal device 200 changes the beam direction used in the communication, the operation pattern (a) is carried out. In the operation pattern (a), since neither the base station device 100 nor the terminal device 200 changes the beam direction, the link between the base station device 100 and the terminal device 200 is not disconnected, and the communication continues.

If the base station device 100 changes the beam direction used in the communication and the terminal device 200 does not change the beam direction used in the communication, the operation patter (b) is carried out. The operation pattern (b) is carried out in a case in which the base station device 100 changes the best beam before the operation 1a after the first BFT operation and the second BFT operation are carried out and the link between the base station device 100 and the terminal device 200 is disconnected. If the link is disconnected after the operation 1a, the link connection is refrained from until the operation 2 is carried out after the operation 1 a. The period corresponding to “before the operation 1 a” is not limited to the period after the end of the operation 4 and before the operation 1a but includes, for example, the period after the end of the operation 1a and before the operation 2, the period during the operation 2, the period after the end of the operation 2 and before the operation 4, and the period during the operation 4.

If the base station device 100 does not change the beam direction used in the communication and the terminal device 200 changes the beam direction used in the communication, the operation patter (c) is carried out. The operation pattern (c) is carried out in a case in which the terminal device 200 changes the best beam before the operation 1a after the first BFT operation and the second BFT operation are carried out and the link between the base station device 100 and the terminal device 200 is disconnected. If the link is disconnected after the operation 4, the link connection is refrained from until the operation 5 is carried out. The period corresponding to “before the operation 4” is not limited to the period after the end of the operation 1a and before the operation 4 but includes, for example, the period after the end of the operation 4 and before the operation 5, the period during the operation 5, the period after the end of the operation 5 and before the operation 1a, and the period during the operation 1a.

If the base station device 100 changes the beam direction used in the communication and the terminal device 200 also changes the beam direction used in the communication, any one of the operation pattern (d), the operation pattern (e), and the operation pattern (f) is carried out.

The operation patter (d) is carried out in a case in which the base station device 100 changes the best beam before the operation 1a, the terminal device 200 changes the best beam before the operation 4, and the link between the base station device 100 and the terminal device 200 is disconnected. The operation pattern (e) is carried out in a case in which the base station device 100 and the terminal device 200 change their respective best beams before the operation 1a and the link between the base station device 100 and the terminal device 200 is disconnected. The operation pattern (f) is carried out in a case in which the base station device 100 and the terminal device 200 change their respective best beams before the operation 1a, the terminal device 200 changes the best beam before the operation 4, and the link between the base station device 100 and the terminal device 200 is disconnected.

It is to be noted that the correspondence relationship illustrated in FIG. 9B is merely an example. For example, the operation pattern is modified depending on the timing at which the position of the terminal device 200 changes, the timing at which the terminal device 200 moves, or the communication environment between the base station device 100 and the terminal device 200. For example, even in a case in which neither the base station device 100 nor the terminal device 200 changes the beam direction used in the communication, if it is difficult to transmit and receive a signal (FB, ACK, etc.) between the base station device 100 and the terminal device 200 due to, for example, an influence of interference, another operation pattern other than the operation pattern (a) may be carried out.

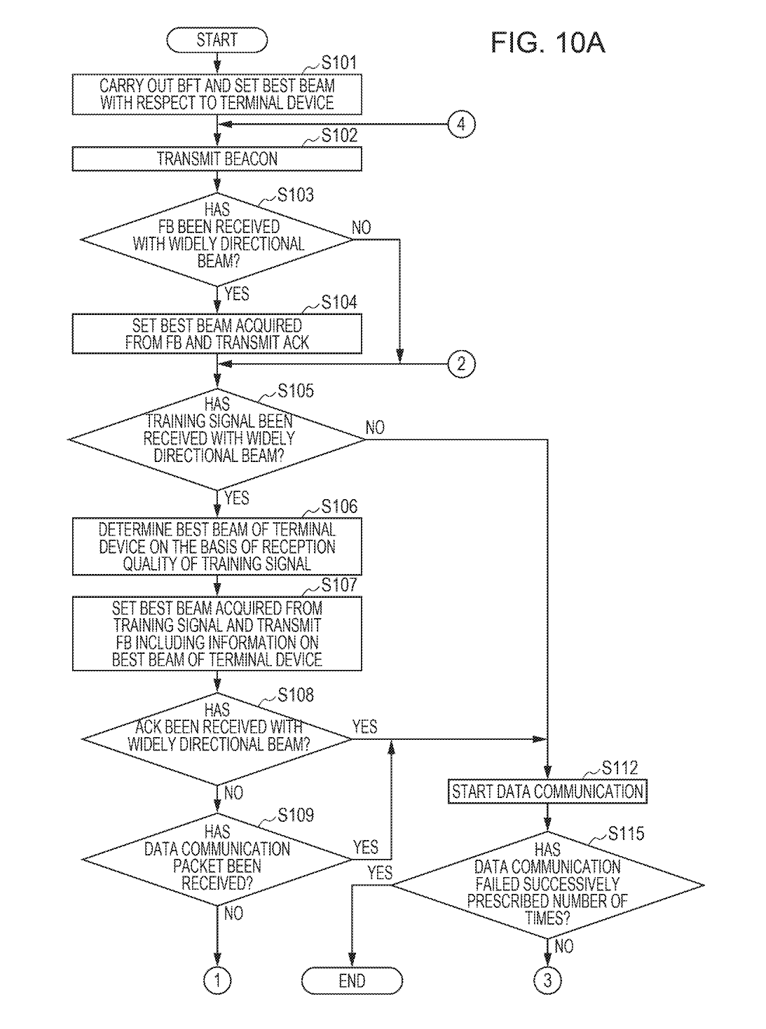

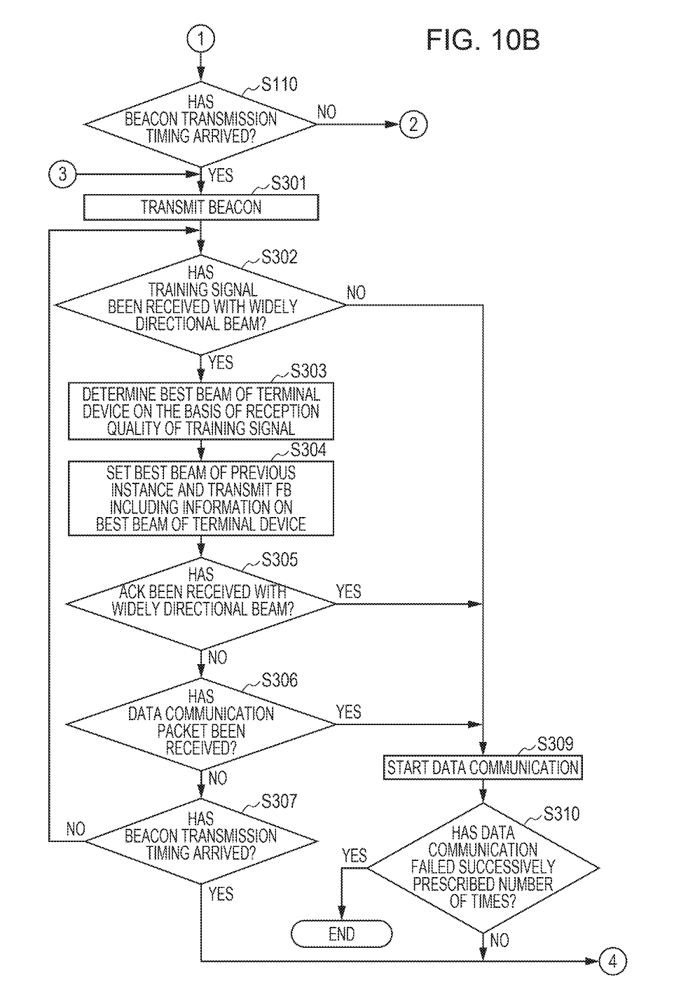

Next, the flow of the base station device 100 according to the second embodiment will be described with reference to FIGS. 10A and 10B. FIGS. 10A and 10B are a flowchart illustrating the processing of the base station device 100 according to the second embodiment. The processing in step S101 to step S110 and the processing in step S112 illustrated in FIG. 10A are similar to the processing illustrated in FIG. 6. Thus, identical step numbers are given, and the descriptions thereof will be omitted.

In FIG. 10A, the processing in step S115 is carried out in place of the processing in step S111 illustrated in FIG. 6. In step S115, after the data communication has started (step S112), the base station device 100 determines whether the data communication has failed successively a prescribed number of times including step S310, which will be described later, and determines whether the condition is suitable for data communication.

Specifically, the communication controller 105 outputs an instruction to the transmission processor 103 directing the transmission processor 103 to transmit a communication packet. The communication processor 103 instructs the beam controller 107 to form a directional beam and transmits a data communication packet via the antenna unit 121. The base station device 100 stands by until the base station device 100 receives a data communication packet from the terminal device 200.

In step S115, in the base station device 100, the communication controller 105 determines whether the condition is suitable for data communication on the basis of whether the reception processor 104 has received a data communication packet from the terminal device 200 via the antenna unit 121.

If the base station device 100 has failed to receive a data communication packet from the terminal device 200 successively a prescribed number of times (YES in step S115), the processing with the terminal device 200 in the base station device 100 is terminated.

If the base station device 100 has received a data communication packet from the terminal device 200 (NO in step S115), the base station device 100 continues with the data communication until the transmission timing of the next beacon, and the flow proceeds to the processing in step S301.

Next, in FIG. 10B, step S301 to step S309 are added after the processing in step S110 illustrated in FIG. 6 or after the processing in step S115 added in FIG. 10A. Specifically, in FIG. 6, the flow returns to the processing in step S102 (the operation 1 illustrated in FIG. 4) if the transmission timing of the next beacon has arrived (YES in step S110) or after the data communication is carried out until the transmission timing of the next beacon (after the processing in step S112). In FIG. 10B, the flow proceeds to the processing in step S301 (the operation 4 illustrated in FIG. 8B).

In a similar manner to step S102, in step S301, the base station device 100 transmits a beacon while switching the narrowly directional beam.

Specifically, the communication controller 105 outputs an instruction to the transmission processor 103 directing the transmission processor 103 to transmit a beacon frame. The transmission processor 103 appends the beam number to each beacon frame. Then, the transmission processor 103 cooperates with the beam controller 107 and transmits a beacon periodically via the antenna unit 121 by using the narrowly directional beam corresponding to the beam number.

In step S302, the base station device 100 determines whether the base station device 100 has received a training signal from the terminal device 200 by using a widely directional beam.

Specifically, the beam controller 107 of the base station device 100 instructs the antenna unit 121 to form a widely directional reception beam. The antenna unit 121 forms a widely directional reception beam and stands by until the antenna unit 121 receives a training signal from the terminal device 200. Then, the reception processor 104 determines whether the reception processor 104 has received a training signal from the terminal device 200 via the antenna unit 121.

If the base station device 100 has received no training signal from the terminal device 200 (NO in step S302), in step S309, the base station device 100 starts data communication with the terminal device 200. The data communication continues until the transmission timing of the next beacon.

If the base station device 100 has received a training signal from the terminal device 200 (YES in step S302), in step S303, the base station device 100 determines the best beam of the terminal device 200 of the current instance on the basis of the reception quality of the received training signal.

The quality information acquirer 106 calculates the reception quality of each training signal transmitted by the terminal device 200, determines the beam number with the highest reception quality, and outputs the determined beam number to the communication controller 105.

Then, in step S304, the base station device 100 sets the best beam of the base station device 100 of the previous instance. Then, the base station device 100 transmits an FB including the information indicating the best beam of the terminal device 200 of the current instance determined in step S303.

Specifically, upon having acquired the beam direction information indicating the best beam of the terminal device 200 of the current instance from the quality information acquirer 106, the communication controller 105 outputs an instruction to the transmission processor 103 directing the transmission processor 103 to transmit an FB including the beam direction information indicating the best beam of the terminal device 200 of the current instance. In addition, upon the communication controller 105 having output an instruction to transmit an FB to the beam controller 107, the beam controller 107 instructs the antenna unit 121 to form a narrowly directional transmission beam used in the previous instance of communication (i.e., the best beam of the previous instance). The antenna unit 121 forms the narrowly directional transmission beam used in the previous instance of data communication. Then, the transmission processor 103 transmits an FB via the antenna unit 121.

In step S305, the base station device 100 determines whether the base station device 100 has received an ACK from the terminal device 200 by using a widely directional beam.

Specifically, the beam controller 107 of the base station device 100 instructs the antenna unit 121 to form a widely directional reception beam. The antenna unit 121 forms a widely directional reception beam and stands by until the antenna unit 121 receives an ACK from the terminal device 200. The reception processor 104 determines whether the reception processor 104 has received an ACK from the terminal device 200 via the antenna unit 121.

If the base station device 100 has received an ACK from the terminal device 200 (YES in step S305), in step S309, the base station device 100 starts data communication with the terminal device 200. The data communication continues until the transmission timing of the next beacon.

If the base station device 100 has received no ACK from the terminal device 200 (NO in step S305), in step S306, the base station device 100 determines whether the base station device 100 has received a data communication packet from the terminal device 200.

If the base station device 100 has received a data communication packet from the terminal device 200 (YES in step S306), in step S309, the base station device 100 starts data communication with the terminal device 200. The data communication continues until the transmission timing of the next beacon.

If the base station device 100 has received no data communication packet from the terminal device 200 (NO in step S306), in step S307, the base station device 100 determines whether the transmission timing of the next beacon has arrived.

If the base station device 100 determines that the transmission timing of the next beacon has arrived (YES in step S307), the flow returns to the processing in step S102. If the base station device 100 determines that the transmission timing of the next beacon has not arrived (NO in step S307), the flow returns to the processing in step S302.

In step S310, the base station device 100 determines whether the data communication has failed successively a prescribed number of times including step S115 after the data communication has started (step S309) and determines whether the condition is suitable for data communication.

Specifically, the communication controller 105 outputs an instruction to the transmission processor 103 directing the transmission processor 103 to transmit a communication packet. The communication processor 103 instructs the beam controller 107 to form a directional beam and transmits a data communication packet via the antenna unit 121. The base station device 100 stands by until the base station device 100 receives a data communication packet from the terminal device 200. Thereafter, in the base station device 100, the communication controller 105 determines whether the condition is suitable for data communication on the basis of whether the reception processor 104 has received a data communication packet from the terminal device 200 via the antenna unit 121.

If the base station device 100 has failed to receive a data communication packet from the terminal device 200 successively a prescribed number of times (YES in step S310), the processing with the terminal device 200 in the base station device 100 is terminated.

If the base station device 100 has received a data communication packet from the terminal device 200 (NO in step S310), the base station device 100 continues with the data communication until the transmission timing of the next beacon, and the flow returns to the processing in step S102.

In step S302 described above, the base station device 100 may stand by until the transmission timing of the next beacon if the base station device 100 does not carry out data communication with the terminal device 200.

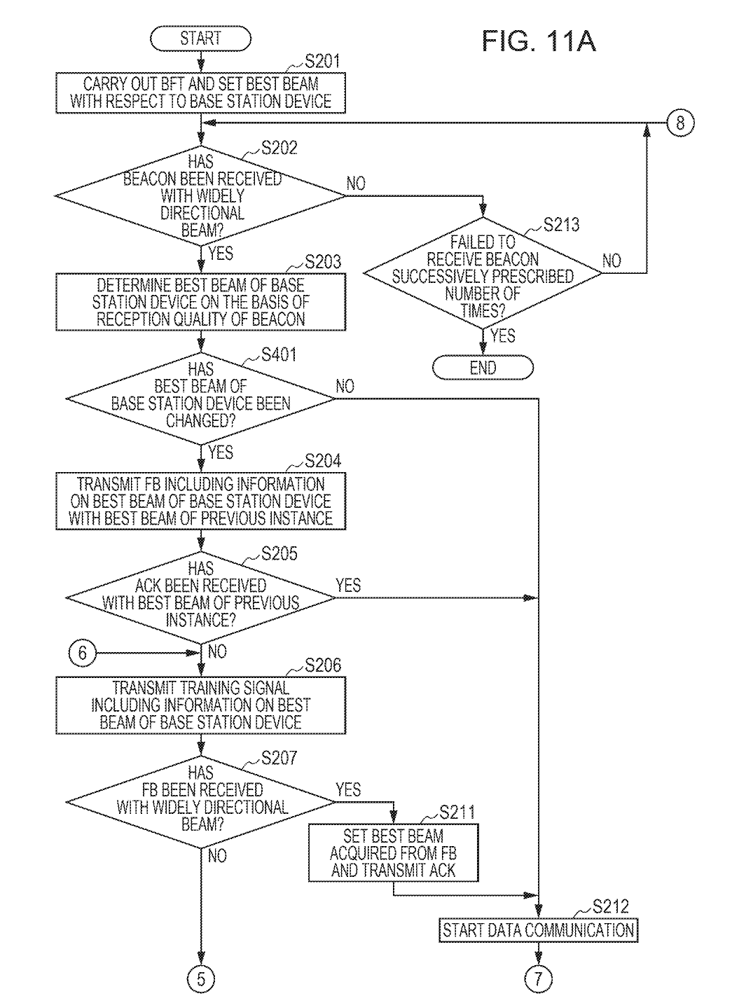

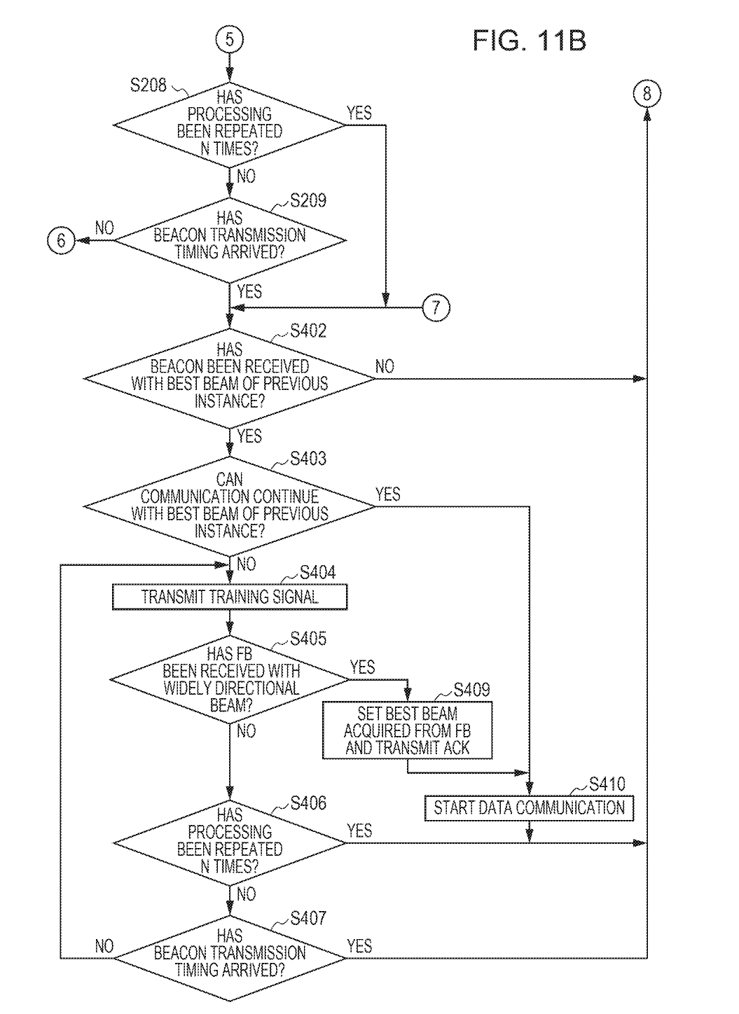

Next, the flow of the terminal device 200 according to the second embodiment will be described with reference to FIGS. 11A and 11B. FIGS. 11A and 11B are a flowchart illustrating the processing of the terminal device 200 according to the second embodiment. It is to be noted that, in FIGS. 11A and 11B, processing similar to the processing illustrated in FIG. 7 is given an identical step number, and descriptions thereof will be omitted.

In FIG. 11A, the processing in step S401 is added between the processing in step S203 and the processing in step S204 illustrated in FIG. 7.

In addition, step S402 to step S410 are added after the processing in step S208, after the processing in step S209, after the processing in step S212, or after the processing in step S213 illustrated in FIG. 7. Specifically, in FIG. 7, the flow returns to the processing in step S202 (the operation 1 illustrated in FIG. 4) if the processing in step S206 and step S207 has been repeated N times (YES in step S208), if the transmission timing of the next beacon has arrived (YES in step S209), or after the data communication has been carried out until the transmission timing of the next beacon (after the processing in step S212). In FIG. 11B, the flow proceeds to the processing in step S402 (the operation 4 illustrated in FIG. 8B).

Hereinafter, the processing in step S401 to step S410 will be described. In step S401, the terminal device 200 compares the best beam of the base station device 100 of the current instance determined in step S203 with the best beam of the base station device 100 of the previous instance and determines whether to change the best beam of the base station device 100.

Here, the terminal device 200 stores, into the information storage 108 of the terminal device 200, the best beam of the base station device 100 each time the best beam of the base station device 100 is determined. Then, if the terminal device 200 determines in the operation 1a (refer to FIG. 8A) that the best beam of the base station device 100 of the current instance is identical to the best beam of the base station device 100 of the previous instance stored in the information storage 108 of the terminal device 200, the terminal device 200 starts the data communication without carrying out the operation 2 and the operation 3 (refer to FIG. 8A) in a similar manner to the previous instance since the terminal device 200 can communicate with the base station device 100.

On the other hand, if the best beam of the base station device 100 is to be changed (YES in step S401), the flow proceeds to the processing in step S204. If the best beam of the base station device 100 is not to be changed (NO in step S401), the flow proceeds to the processing in step S212.

In step S402, the terminal device 200 determines whether the terminal device 200 has received a beacon from the base station device 100 by using the best beam of the previous instance.

Specifically, the beam controller 107 of the terminal device 200 instructs the antenna unit 121 to form a narrowly directional transmission beam used in the previous instance of data communication (i.e., the best beam of the previous instance). The antenna unit 121 forms the narrowly directional transmission beam used in the previous instance of data communication and stands by until the antenna unit 121 receives a beacon from the base station device 100. The reception processor 104 determines whether the reception processor 104 has received a beacon from the base station device 100 via the antenna unit 121.

If the terminal device 200 has received no beacon from the base station device 100 (NO in step S402), the flow returns to the processing in step S202.

If the terminal device 200 has received a beacon from the base station device 100 (YES in step S402), in step S403, the terminal device 200 determines whether to continue with the data communication by using the best beam of the previous instance.

Specifically, the quality information acquirer 106 calculates the reception quality of each beacon transmitted by the base station device 100. The quality information acquirer 106 outputs the calculated reception quality to the communication controller 105. The communication controller 105 acquires the information on the beam direction currently set by the base station device 100 from the information storage 108, calculates the reception quality of the acquired beam direction, and compares the calculated reception quality against a predetermined threshold value to determine whether the calculated reception quality satisfies the reception quality in the data communication. Then, the communication controller 105 determines to continue with the data communication if the reception quality is no lower than the threshold value and determines not to continue with the data communication if the reception quality is lower than the threshold value.

If the terminal device 200 determines to continue with the data communication by using the best beam of the previous instance (YES in step S403), in step S410, the terminal device 200 starts data communication with the base station device 100. The data communication continues until the transmission timing of the next beacon.

If the terminal device 200 determines not to continue with the data communication by using the best beam of the previous instance (NO in step S403), the terminal device 200 transmits a training signal while switching the narrowly directional beam.

Specifically, the communication controller 105 outputs an instruction to the transmission processor 103 directing the transmission processor 103 to transmit a training signal. The transmission processor 103 appends the beam number to each training signal including the beam direction information. Then, the transmission processor 103 transmits a training signal periodically via the antenna unit 121 by using the narrowly directional beam corresponding to the beam number under the control of the beam controller 107.

In step S405, the terminal device 200 determines whether the terminal device 200 has received an FB from the base station device 100 by using a widely directional beam.

Specifically, the beam controller 107 of the terminal device 200 instructs the antenna unit 121 to form a widely directional reception beam. The antenna unit 121 forms a widely directional reception beam and stands by until the antenna unit 121 receives an FB from the base station device 100. The reception processor 104 determines whether the reception processor 104 has received an FB from the base station device 100 via the antenna unit 121.

If the terminal device 200 has received an FB from the base station device 100 (YES in step S405), in step S409, the terminal device 200 sets the best beam of the terminal device 200 of the current instance indicated by the beam direction information included in the FB. Then, the terminal device 200 transmits an ACK to the base station device 100 by using the set best beam.

Specifically, the quality information acquirer 106 acquires the beam direction information of the terminal device 200 included in the FB and outputs the beam direction information to the beam controller 107. The beam controller 107 sets the best beam indicated by the beam direction information into the antenna unit 121. Upon having acquired the FB from the quality information acquirer 106, the communication controller 105 outputs an instruction to the transmission processor 103 directing the transmission processor 103 to transmit an ACK to the terminal device 200. The transmission processor 103 transmits an ACK via the antenna unit 121.

After the processing in step S409, in step S410, the terminal device 200 starts data communication with the base station device 100. The data communication continues until the transmission timing of the next beacon.

If the terminal device 200 has received no FB from the base station device 100 (NO in step S405), in step S406, the terminal device 200 determines whether the processing in step S404 and step S405 has been repeated N times.

If the processing in step S404 and step S405 has not been repeated N times (NO in step S406), in step S407, the terminal device 200 determines whether the transmission timing of the next beacon has arrived.

If the transmission timing of the next beacon has not arrived (NO in step S407), the flow returns to the processing in step S404.

If the processing in step S404 and step S405 has been repeated N times (YES in step S406) or if the transmission timing of the next beacon has arrived (YES in step S407), the flow returns to the processing in step S202.

As described thus far, according to the second embodiment, if the beam direction of the terminal device 200 is not changed, the base station device 100 and the terminal device 200 can start data communication without the terminal device 200 transmitting a training signal to the base station device 100 for determining the best beam of the terminal device 200. With this configuration, the frequency of transmitting and receiving training signals can be reduced, and thus a decrease in the communication throughput can be suppressed.

In addition, according to the second embodiment, instead of transmitting a training signal for determining the best beam of the base station device 100, the base station device 100 can use a beacon transmitted periodically. With this configuration, the frequency of transmitting and receiving training signals can be further reduced, and thus a decrease in the communication throughput can be suppressed.

In addition, according to the second embodiment, the terminal device 200 determines whether to change the beam direction of the base station device 100 on the basis of the beacon received from the base station device 100. Then, if the beam direction of the base station device 100 is not changed, the data communication can be started after the base station device 100 transmits a beacon. With this configuration, the processing in which the terminal device 200 transmits an FB to the base station device 100 and the processing in which the base station device 100 transmits an ACK to the terminal device 200 can be omitted, and a decrease in the communication throughput can be suppressed.

In addition, according to the second embodiment, the terminal device 200 receives the beacon transmitted by the base station device 100 by using the best beam of the previous instance and determines whether to continue with the communication with the base station device 100. Then, if the communication is to continue, the base station device 100 and the terminal device 200 start data communication without the terminal device 200 transmitting a training signal to the base station device 100 for determining the best beam of the terminal device 200. With this configuration, the frequency of transmitting and receiving training signals can be reduced, and thus a decrease in the communication throughput can be suppressed.

Thus far, various embodiments have been described with reference to the drawings, but it is needless to say that the present disclosure is limited to these examples. It is apparent that a person skilled in the art can conceive of various modified examples and revised examples within the spirit set forth by the appended claims, and it is appreciated that such modified examples and revised examples are encompassed by the technical scope of the present disclosure. Unless departing from the spirit of the present disclosure, the constituent elements of the embodiments described above may be combined as desired.

Although the present disclosure is described with an example in which the present disclosure is implemented by hardware in the foregoing embodiments, the present disclosure can also be implemented by software in conjunction with hardware.

In addition, each functional block used in the description of the foregoing embodiments is typically implemented as a large-scale integration (LSI), that is, an integrated circuit. An integrated circuit may control each functional block used in the description of the foregoing embodiments and include an input and an output. The functional blocks may each be implemented by a single chip, or part or all of the functional blocks may be implemented by a single chip. Although an LSI is illustrated, depending on the difference in the degree of integration, such a circuit may also be called an IC, a system LSI, a super LSI, or an ultra LSI.

In addition, the technique of integrating into a circuit is not limited to an LSI, and the functional blocks may be implemented by a dedicated circuit or a general-purpose processor. A field-programmable gate array (FPGA) that can be programmed after an LSI is fabricated or a reconfigurable processor in which the connection or the setting of the circuit cell within the LSI can be reconfigured may also be used.

Furthermore, when a technique for integrating into a circuit that replaces an LSI appears through the advancement in the semiconductor technology or a derived different technique, the functional blocks may be integrated by using such a different technique. An application of biotechnology or the like is a conceivable possibility.

It is to be noted that the present disclosure can be expressed as a control method to be carried out in a wireless communication device or a control device. In addition, the present disclosure can be expressed as a program for causing a computer to carry out such a control method. Furthermore, the present disclosure can be expressed as a recording medium storing such a program in a state in which a computer can read the program. In other words, the present disclosure can be expressed as any of the categories including an apparatus, a method, a program, and a recording medium.

### Recapitulation of the Present Disclosure

A terminal device according to the present disclosure includes a communicator that carries out first data communication with a base station device by using a first beam and then receives, by using a reception beam, a plurality of first signals transmitted by the base station device by using respective transmission beams; and a determiner that calculates a reception quality of the plurality of first signals and determines a second beam of which the reception quality is the highest among the plurality of transmission beams. The communicator transmits a feedback signal including information indicating the second beam to the base station device by using the first beam and starts second data communication with the base station device by using the first beam in a case in which the communicator has received, from the base station device, a response signal indicating that the base station device has received the feedback signal.

In the terminal device according to the present disclosure, the first signal is included in a beacon that the base station device transmits to the terminal device.

In the terminal device according to the present disclosure, the determiner determines whether a determination result of a previous instance is the second beam, and in a case in which the determination result of the previous instance is the second beam, the communicator starts the second data communication by using the first beam without transmitting the feedback signal.

In the terminal device according to the present disclosure, in a case in which the communicator has received, by using the first beam, a plurality of third signals transmitted by the base station device by using the respective transmission beams after the second data communication, the determiner determines whether a reception quality of the third signals is no lower than a threshold value, and in a case in which the reception quality of the third signals is no lower than the threshold value, the communicator starts third data communication after the second data communication with the base station device.

A base station device according to the present disclosure includes a controller that generates a plurality of first signals; and a communicator that carries out first data communication with a terminal device that uses a first beam and then transmits, to the terminal device, the plurality of first signals by using respective transmission beams. The plurality of transmission beams include a second beam of which a reception quality is the highest in a case in which the first signals are received with the use of a reception beam of the terminal device, and in a case in which a feedback signal including the second beam has been received from the terminal device, the communicator transmits a response signal to the terminal device by using the second beam and starts second data communication with the terminal device.

In the base station device according to the present disclosure, the first signals are included in a beacon transmitted to the terminal device.

A wireless communication system according to the present disclosure includes a base station device that includes a controller that generates a plurality of first signals, and a second communicator that transmits the plurality of first signals by using respective second transmission beams; and a terminal device that includes a first communicator that carries out first data communication with the base station device by using a first beam and then receives the plurality of first signals by using a reception beam, and a first determiner that calculates a reception quality of the plurality of first signals and determines a second beam of which the reception quality is the highest among the plurality of second transmission beams. The first communicator transmits a first feedback signal including information indicating the second beam to the base station device by using the first beam. In a case in which the first feedback signal has been received, the second communicator transmits a first response signal to the terminal device by using the second beam. In a case in which the first response signal has been received from the base station device with the use of the first beam, the first communicator starts second data communication with the base station device after the first data communication.

In the wireless communication system according to the present disclosure, in a case in which the first response signal is not received, the first communicator transmits, to the base station device, a plurality of third signals including information indicating the second beam by using the respective first transmission beams. The base station device includes a second determiner that calculates a reception quality of the plurality of third signals received from the terminal device and determines a third beam of which the reception quality is the highest among the plurality of first transmission beams. The second communicator transmits a second feedback signal including information indicating the third beam to the terminal device by using the second beam. In a case in which the second feedback signal has been received, the first communicator transmits a second response signal to the base station device by using the third beam. In a case in which the second response signal has been received from the terminal device, the second communicator starts third data communication with the terminal device.

In the wireless communication system according to the present disclosure, the first determiner determines whether a determination result of a previous instance is the second beam, and in a case in which the determination result of the previous instance is the second beam, the first communicator starts the second data communication by using the first beam without transmitting the first feedback signal.

In the wireless communication system according to the present disclosure, the second communicator transmits each of a plurality of fourth signals by using each of the plurality of second transmission beams after the second data communication. The first communicator receives the plurality of fourth signals by using the first beam. The first determiner determines whether the reception quality of the fourth signals is no lower than a threshold value. In a case in which the reception quality of the fourth signals is no lower than the threshold value, the first communicator starts fourth data communication with the base station device.

In the wireless communication system according to the present disclosure, in a case in which the reception quality of the fourth signals is lower than the threshold value, the first communicator transmits, to the base station device, a plurality of fifth signals by using respective first transmission beams. The base station device includes a second determiner that calculates a reception quality of the plurality of fifth signals received from the terminal device and determines a fourth beam of which the reception quality is the highest among the plurality of first transmission beams. The second communicator transmits a third feedback signal including information indicating the fourth beam to the terminal device by using the second beam. In a case in which the third feedback signal has been received, the first communicator transmits a third response signal to the base station device by using the fourth beam. In a case in which the third response signal has been received from the terminal device, the second communicator starts fifth data communication with the terminal device.

The present disclosure is useful in a wireless communication system that carries out communication with the use of beamforming.

What is claimed is:

1. A terminal device, comprising:
communication circuitry that carries out first data communication with a base station device by using a first beam and then receives, by using a reception beam, a plurality of first signals transmitted by the base station device by using respective transmission beams; and
determination circuitry that calculates a reception quality of the plurality of first signals and determines a second beam of which the reception quality is the highest among the plurality of transmission beams,
wherein the communication circuitry transmits a feedback signal including information indicating the second beam to the base station device by using the first beam and starts second data communication with the base station device by using the first beam in a case in which the communicator receives, from the base station device, a response signal indicating that the feedback signal being received by the base station device.

2. The terminal device according to claim 1,
wherein the first signal is included in a beacon that the base station device transmits to the terminal device.

3. The terminal device according to claim 1,
wherein the determination circuitry determines whether a determination result in the first data communication is the second beam, and
wherein the communication circuitry starts the second data communication by using the first beam without transmitting the feedback signal in a case in which the determination circuitry result in the first data communication is the second beam.

4. The terminal device according to claim 3,
wherein, in a case in which the communication circuitry receives, by using the first beam, a plurality of third signals transmitted by the base station device by using respective transmission beams after the second data communication, the determination circuitry determines whether a reception quality of the third signals is no lower than a threshold value, and
wherein, in a case in which the reception quality of the third signals is no lower than the threshold value, the communication circuitry starts third data communication after the second data communication with the base station device.

5. A base station device, comprising:
a controller that generates a plurality of first signals; and
a communication circuitry that carries out first data communication with a terminal device that uses a first beam and then transmits, to the terminal device, the plurality of first signals by using respective transmission beams,
wherein the plurality of transmission beams include a second beam of which reception quality is the highest in a case in which the first signals are received with the use of a reception beam of the terminal device, and
wherein, in a case in which a feedback signal including the second beam is received from the terminal device, the communication circuitry transmits a response signal to the terminal device by using the second beam and starts second data communication with the terminal device.

6. The base station device according to claim 5,
wherein the first signal is included in a beacon transmitted to the terminal device.

7. A wireless communication system, comprising:
a base station device that includes
a controller that generates a plurality of first signals and
a second communication circuitry that transmits the plurality of first signals by using respective second transmission beams; and
a terminal device that includes
a first communication circuitry that carries out first data communication with the base station device by using a first beam and then receives the plurality of first signals by using a reception beam and
a first determination circuitry that calculates a reception quality of the plurality of first signals and determines a second beam of which the reception quality is the highest among the plurality of second transmission beams,
wherein the first communication circuitry transmits a first feedback signal including information indicating the second beam to the base station device by using the first beam,
wherein, in a case in which the first feedback signal is received, the second communication circuitry transmits a first response signal to the terminal device by using the second beam, and
wherein, in a case in which the first response signal is received from the base station device by using the first beam, the first communication circuitry starts second data communication with the base station device after the first data communication.

8. The wireless communication system according to claim 7,
wherein, in a case in which the first response signal is not received, the first communication circuitry transmits, to the base station device, a plurality of third signals including information indicating the second beam by using respective first transmission beams,
wherein the base station device includes a second determination circuitry that calculates a reception quality of the plurality of third signals received from the terminal device and determines a third beam of which the reception quality is the highest among the plurality of first transmission beams,
wherein the second communication circuitry transmits a second feedback signal including information indicating the third beam to the terminal device by using the second beam,
wherein, in a case in which the second feedback signal is received, the first communication circuitry transmits a second response signal to the base station device by using the third beam, and
wherein in a case in which the second response signal is received from the terminal device, the second communication circuitry starts third data communication with the terminal device.

9. The wireless communication system according to claim 7,
wherein the first determination circuitry determines whether a determination result in the first data communication is the second beam, and
wherein, in a case in which the determination result in the first data communication is the second beam, the first communication circuitry starts the second data communication by using the first beam without transmitting the first feedback signal.

10. The wireless communication system according to claim 9,
wherein the second communication circuitry transmits each of a plurality of fourth signals by using each of the plurality of second transmission beams after the second data communication,
wherein the first communication circuitry receives the plurality of fourth signals by using the first beam,
wherein the first determination circuitry determines whether the reception quality of the fourth signals is no lower than a threshold value, and
wherein, in a case in which the reception quality of the fourth signals is no lower than the threshold value, the first communication circuitry starts fourth data communication with the base station device.

11. The wireless communication system according to claim 10,
wherein, in a case in which the reception quality of the fourth signals is lower than the threshold value, the first communication circuitry transmits, to the base station device, a plurality of fifth signals by using the respective first transmission beams,
wherein the base station device includes a second determination circuitry that calculates a reception quality of the plurality of fifth signals received from the terminal device and determines a fourth beam of which the reception quality is the highest among the plurality of first transmission beams,
wherein the second communication circuitry transmits a third feedback signal including information indicating the fourth beam to the terminal device by using the second beam,
wherein, in a case in which the third feedback signal is received, the first communication circuitry transmits a third response signal to the base station device by using the fourth beam, and
wherein in a case in which the third response signal is received from the terminal device, the second communication circuitry starts fifth data communication with the terminal device.
